(19) United States
(12) Patent Application Publication
(10) Pub. No.: US 2025/0235783 A1
(43) Pub. Date: Jul. 24, 2025

(54) NON-TRANSITORY COMPUTER READABLE MEDIUM, INFORMATION PROCESSING METHOD, AND GAME APPARATUS

(71) Applicant: CYGAMES, INC., Tokyo (JP)

(72) Inventors: Yuichiro Sato, Tokyo (JP); Naoyuki Miyashita, Tokyo (JP); Kei Kawaguchi, Tokyo (JP); Ryosuke Tsuboi, Tokyo (JP); Junya Kumada, Tokyo (JP); Yu Matsuo, Tokyo (JP)

(73) Assignee: CYGAMES, INC., Tokyo (JP)

(21) Appl. No.: 19/061,425

(22) Filed: Feb. 24, 2025

Related U.S. Application Data
(63) Continuation of application No. PCT/JP2023/027239, filed on Jul. 25, 2023.

(30) Foreign Application Priority Data
Aug. 31, 2022 (JP) 2022-138372

(51) Int. Cl. A63F 13/52

(52) U.S. Cl. CPC A63F 13/52

(57) ABSTRACT

A non-transitory computer readable medium stores a program causing a computer to execute displaying, in an arrangement region in a recognizable manner, a plurality of game media each of which is associated with a display mode and a performance, and when a specific game medium associated with a specific display mode and a specific performance out of the plurality of game media is displayed in the arrangement region and a predetermined operation is input with respect to the specific game medium, changing one or both of the specific display mode and the specific performance to a preset display mode or a preset performance when a specific condition set in advance is not satisfied, and changing one or both of the specific display mode and the specific performance to any of a plurality of the display modes or the performances when the specific condition is satisfied.

### CROSS REFERENCE TO RELATED APPLICATIONS

This application is a continuation application of International Application No. PCT/JP2023/027239, filed on Jul. 25, 2023, which claims priority to Japanese Patent Application No. 2022-138372, filed on Aug. 31, 2022, the entire contents of which are incorporated by reference herein.

### BACKGROUND ART

### Technical Field

The present invention relates to an information processing program, an information processing method, and a game apparatus.

In the related art, digital card games enabling players to play against each other through communication have been proposed. As one such digital card game, a game in which a card displayed in an area (field) is fused to another card to summon a new card has been described in Patent Document 1.

### CITATION LIST

### Patent Literature

Patent Document 1: JP 6804675 B

### SUMMARY OF INVENTION

### Technical Problem

There is a demand for further improvement in strategic performance in a game enabling match-up as described above.

An object of the present invention is to provide an information processing system, an information processing method, and an information processing program capable of improving strategic performance.

### Solution to Problem

In order to solve the above-described problem, an information processing program causes a computer to execute:
displaying, in an arrangement region in a recognizable manner, a game medium of a player and a game medium of an opponent out of a plurality of game media each of which is associated with a display mode and a performance;
progressing a game based on at least an operation input with respect to the game medium displayed in the arrangement region; and
when a specific game medium associated with a specific display mode and a specific performance out of the plurality of game media is displayed in the arrangement region and a predetermined operation is input with respect to the specific game medium, changing one or both of the specific display mode and the specific performance to a preset display mode or a preset performance when a specific condition set in advance is not satisfied, and changing one or both of the specific display mode and the specific performance to any of a plurality of the display modes or the performances when the specific condition is satisfied.

The plurality of game media include a plurality of special game media each of which is different from the specific game medium in one or both of a display mode and a performance. In the changing the display mode or the performance, the specific game medium may be changed to any of the plurality of special game media when the specific condition is satisfied.

In addition, the computer is further caused to execute prompting the player to select a special game medium of the plurality of special game media when the specific condition is satisfied. In the changing the display mode or the performance, the specific game medium may be changed to the special game medium selected by the player.

In addition, one or both of the display mode and the performance of the special game medium may be different from the preset display mode or the preset performance resulting from the changing when the specific condition is not satisfied.

In addition, the specific condition may be determined to have been satisfied when a progress status of the game during a predetermined period satisfies a condition set in advance.

In order to solve the above-described problem, an information processing method is an information processing method executed by one or a plurality of computers and includes:
displaying, in an arrangement region in a recognizable manner, a game medium of a player and a game medium of an opponent out of a plurality of game media each of which is associated with a display mode and a performance;
progressing a game based on at least an operation input with respect to the game medium displayed in the arrangement region; and
when a specific game medium associated with a specific display mode and a specific performance out of the plurality of game media is displayed in the arrangement region and a predetermined operation is input with respect to the specific game medium, changing one or both of the specific display mode and the specific performance to a preset display mode or a preset performance when a specific condition set in advance is not satisfied, and changing one or both of the specific display mode and the specific performance to any of a plurality of the display modes or the performances when the specific condition is satisfied.

In order to solve the above-described problem, a game apparatus includes one or a plurality of computers, the one or a plurality of computers being configured to execute:
displaying, in an arrangement region in a recognizable manner, a game medium of a player and a game medium of an opponent out of a plurality of game media each of which is associated with a display mode and a performance;
progressing a game based on at least an operation input with respect to the game medium displayed in the arrangement region; and
when a specific game medium associated with a specific display mode and a specific performance out of the plurality of game media is displayed in the arrangement region and a predetermined operation is input with respect to the specific game medium, changing one or both of the specific display mode and the specific performance to a preset display mode or a preset performance when a specific condition set in advance is not satisfied, and changing one or both of the specific display mode and the specific performance to any of a plurality of the display modes or the performances when the specific condition is satisfied.

### Effects of Disclosure

According to the present invention, strategic performance can be improved.

### BRIEF DESCRIPTION OF DRAWINGS

FIG. 1 is an explanatory diagram illustrating a schematic configuration of an information processing system.

FIG. 2A is a diagram illustrating a hardware configuration of a player terminal. FIG. 2B is a diagram illustrating a hardware configuration of a server.

FIG. 3A is a diagram illustrating an example of a home screen. FIG. 3B is a diagram illustrating an example of a card setting screen. FIG. 3C is a diagram illustrating an example of a deck selection screen. FIG. 3D is a diagram illustrating an example of a deck edit screen in an initial state.

FIG. 4A is a diagram illustrating an example of the deck edit screen during edit. FIG. 4B is a diagram illustrating an example of a card list screen. FIG. 4C is a diagram illustrating an example of a card creation screen. FIG. 4D is a diagram illustrating an example of a card detail screen.

FIG. 5 is a diagram illustrating an example of a card battle game screen.

FIG. 6A is a diagram illustrating an example of a follower card. FIG. 6B is a diagram illustrating an example of a spell card. FIG. 6C is a diagram illustrating an example of an amulet card.

FIG. 7 is a diagram illustrating examples of abilities.

FIG. 8A is a first diagram illustrating an example of the transition of a card battle screen. FIG. 8B is a second diagram illustrating an example of the transition of the card battle screen. FIG. 8C is a third diagram illustrating an example of the transition of the card battle screen.

FIG. 9A is a fourth diagram illustrating an example of the transition of the card battle screen. FIG. 9B is a fifth diagram illustrating an example of the transition of the card battle screen. FIG. 9C is a sixth diagram illustrating an example of the transition of the card battle screen.

FIG. 10A is a seventh diagram illustrating an example of the transition of the card battle screen. FIG. 10B is an eighth diagram illustrating an example of the transition of the card battle screen. FIG. 10C is a ninth diagram illustrating an example of the transition of the card battle screen.

FIG. 11A is a tenth diagram illustrating an example of the transition of the card battle screen. FIG. 11B is an eleventh diagram illustrating an example of the transition of the card battle screen.

FIG. 12A is a first diagram illustrating an example of a battle screen at the time of evolution. FIG. 12B is a second diagram illustrating an example of the battle screen at the time of evolution.

FIG. 13 is a diagram illustrating an example of a card detail tab.

FIG. 14A is a first diagram illustrating an example of an evolutionary animation. FIG. 14B is a second diagram illustrating an example of the evolutionary animation.

FIG. 15 is a diagram illustrating examples of specific cards and special cards.

FIG. 16A is a diagram illustrating an example of a special card selection screen. FIG. 16B is a third diagram illustrating an example of an evolutionary animation.

FIG. 17 is a functional block diagram of the player terminal.

FIG. 18 is a functional block diagram of the server.

FIG. 19 is a sequence diagram illustrating processing of the player terminal and the server.

FIG. 20 is a flowchart illustrating an example of card battle game execution processing in the player terminal.

FIG. 21 is a first flowchart illustrating an example of own turn control processing in the player terminal.

FIG. 22 is a second flowchart illustrating an example of the own turn control processing in the player terminal.

FIG. 23 is a flowchart illustrating an example of opponent's turn control processing in the player terminal.

FIG. 24 is a flowchart illustrating an example of the card battle game execution processing in the server.

### DESCRIPTION OF EMBODIMENTS

Hereinafter, an aspect of an embodiment of the present invention will be described in detail with reference to the accompanying drawings. Numerical values and the like described in the embodiment are merely examples for facilitating understanding, and do not limit the present invention unless otherwise specified. In the present specification and the drawings, elements having substantially the same function and configuration are denoted by the same reference sign, and redundant description thereof will be omitted, and elements not directly related to the present invention will not be illustrated.

### Overall Configuration of Information Processing System S

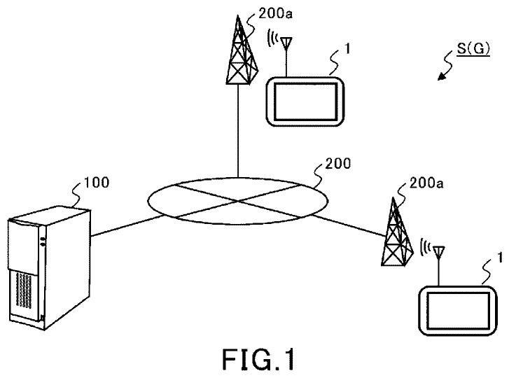

FIG. 1 is an explanatory diagram illustrating a schematic configuration of an information processing system S. The information processing system S is a so-called client server system including a player terminal 1, server 100, and a communication network 200 including a communication base station 200a.

The player terminal 1 establish can communication with the server 100 via the communication network 200. The player terminal 1 widely includes an electronic device capable of establishing wireless or wired communication connection with the server 100. Examples of the player terminal 1 include a smartphone, a mobile phone, a tablet device, a personal computer, and a game machine. In the present embodiment, a case in which a smartphone is used as the player terminal 1 will be described.

The server 100 is communicatively connected to a plurality of player terminals 1. The server 100 accumulates various types of information (player information) for each player who plays a game. The server 100 updates the accumulated information and controls the progress of the game based on the operation input from the player terminals 1.

The communication base station 200a is connected to the communication network 200, and transmits and receives information to and from the player terminals 1 by wireless communication. The communication network 200 is configured with a mobile phone network, the Internet network, a local area network (LAN), a dedicated line, or the like, and establishes wireless or wired communication connection between the player terminals 1 and the server 100.

In the information processing system S of the present embodiment, the player terminals 1 and the server 100 function as a game apparatus G. Each of the player terminals 1 and the server 100 has a role of controlling the progress of the game, and the game can progress by cooperation between the player terminals 1 and the server 100.

### Hardware Configuration of Player Terminal 1 and Server 100

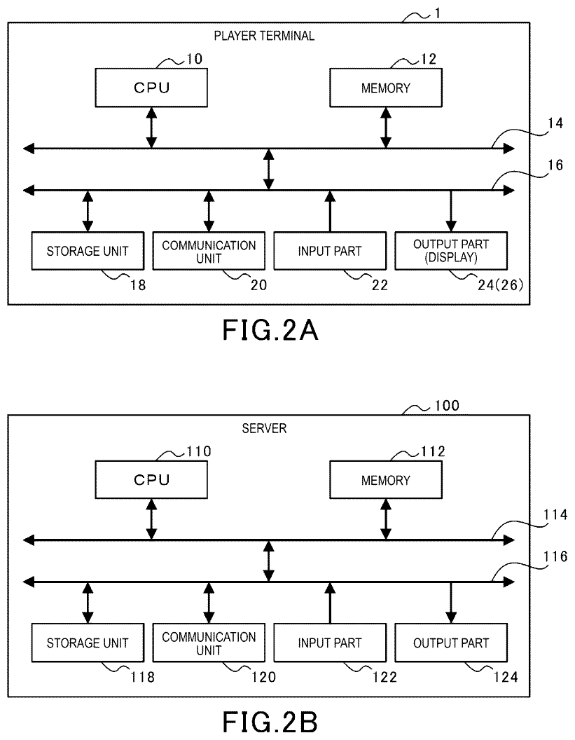

FIG. 2A is a diagram illustrating a hardware configuration of the player terminal 1. FIG. 2B is a diagram illustrating a hardware configuration of the server 100. As illustrated in FIG. 2A, the player terminal 1 includes a central processing unit (CPU) 10, a memory 12, a bus 14, an input/output interface 16, a storage unit 18, a communication unit 20, an input part 22, and an output part 24.

As illustrated in FIG. 2B, the server 100 includes a CPU 110, a memory 112, a bus 114, an input/output interface 116, a storage unit 118, a communication unit 120, an input part 122, and an output part 124.

The configurations and functions of the CPU 110, the memory 112, the bus 114, the input/output interface 116, the storage unit 118, the communication unit 120, the input part 122, and the output part 124 of the server 100 are substantially the same as those of the CPU 10, the memory 12, the bus 14, the input/output interface 16, the storage unit 18, the communication unit 20, the input part 22, and the output part 24 of the player terminal 1, respectively. Thus, the hardware configuration of the player terminal 1 will be described below, and the description of the server 100 will be omitted.

The CPU 10 runs a program stored in the memory 12 to control the progress of the game. The memory 12 is configured with a read only memory (ROM) or a random access memory (RAM), and stores programs and various types of data necessary for controlling the progress of the game. The memory 12 is connected to the CPU 10 via the bus 14.

The input/output interface 16 is connected to the bus 14. The storage unit 18, the communication unit 20, the input part 22, and the output part 24 are connected to the input/output interface 16.

The storage unit 18 is configured with semiconductor memory such as a dynamic random access memory (DRAM) and stores various types of programs and data. In the player terminal 1, the programs and the data stored in the storage unit 18 are loaded into the memory 12 (RAM) by the CPU 10.

The communication unit 20 is communicatively connected to the communication base station 200a in a wireless manner, and transmits and receives information such as various types of data and programs to and from the server 100 via the communication network 200. In the player terminal 1, the programs or the like received from the server 100 are stored in the memory 12 or the storage unit 18.

The input part 22 includes, for example, a touch panel, a button, a keyboard, a mouse, a cross key, an analog controller to which an operation by a player is input (which receives the operation). Alternatively, the input part 22 may be a dedicated controller provided at the player terminal 1 or connected (externally attached) to the player terminal 1. Further, the input part 22 may include an acceleration sensor that detects the inclination or movement of the player terminal 1 or a microphone that detects the voice of a player. That is, the input part 22 includes various devices capable of inputting the intention of a player in a recognizable manner.

The output part 24 includes a display device and a speaker. Note that the output part 24 may be a device connected (externally attached) to the player terminal 1. In the present embodiment, the player terminal 1 includes a display 26 as the output part 24, and a touch panel provided so as to be superimposed on the display 26 as the input part 22.

### Game Content

Next, the content of the game provided by the information processing system S (the game apparatus G) of the present embodiment will be described using an example. The game of the present embodiment is a so-called digital card game. A player can acquire and possess a plurality of types of digital cards (game media, hereinafter simply referred to as cards) provided by an administrator by lottery or the like, and can play a card battle game in which the player plays against a computer or another player using the possessed cards. Hereinafter, the content of the game of the present embodiment will be described in detail.

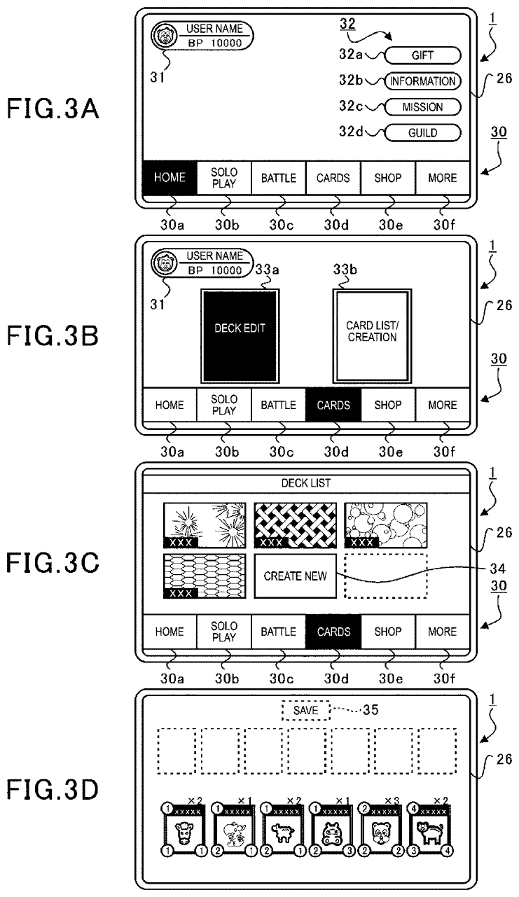

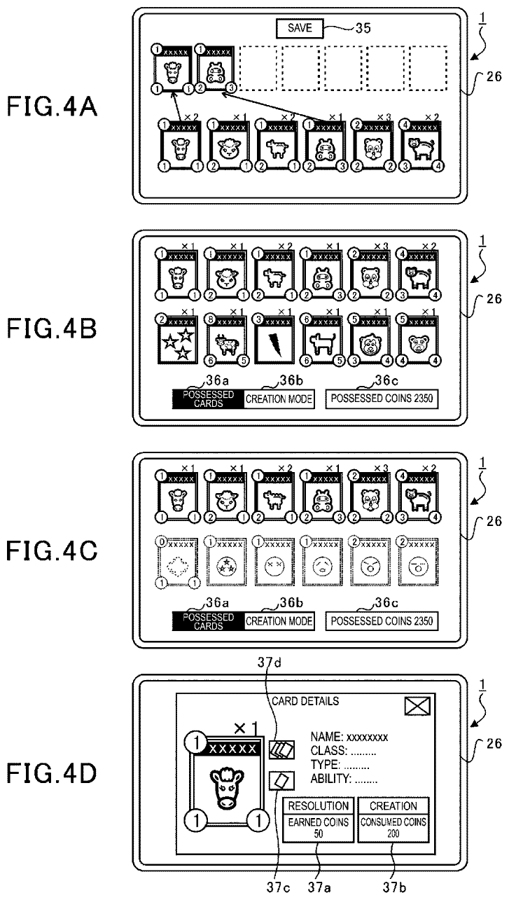

FIG. 3A is a diagram illustrating an example of a home screen. FIG. 3B is a diagram illustrating an example of a card setting screen. FIG. 3C is a diagram illustrating an example of a deck selection screen. FIG. 3D is a diagram illustrating an example of a deck edit screen in an initial state. FIG. 4A is a diagram illustrating an example of the deck edit screen during edit. FIG. 4B is a diagram illustrating an example of a card list screen. FIG. 4C is a diagram illustrating an example of a card creation screen. FIG. 4D is a diagram illustrating an example of a card detail screen.

When an application for the present game is started in the player terminal 1, the communication between the player terminal 1 and the server 100 is started to enter a login state, and the game is started. When the game is started, various types of game screens are displayed on the display 26 of the player terminal 1. In the present embodiment, the game screens are generally classified into normal screens and battle screens.

The normal screens are mainly screens on which a player makes various settings and confirms information. On the other hand, the battle screens are screens that are displayed on the display 26 from the start to the end of the card battle game. Here, all the screens other than the battle screens are the normal screens. The normal screens include a plurality of screens such as a home screen illustrated in FIG. 3A, a card setting screen illustrated in FIG. 3B, a shop screen (not illustrated), and a menu screen.

The home screen illustrated in FIG. 3A is a screen that is first displayed after login. As illustrated in FIG. 3A, on the home screen, a menu bar 30 is displayed at the bottom of the display 26. The menu bar 30 includes a plurality of operation portions that can be operated (tapped) by the player. The menu bar 30 includes a home screen selection operation portion 30a denoted by “Home”, a solo play selection operation portion 30b denoted by “Solo Play”, a multiplay selection operation portion 30c denoted by “Battle”, a card setting screen selection operation portion 30d denoted by “Cards”, a shop screen selection operation portion 30e denoted by “Shop”, and a menu screen selection operation portion 30f denoted by “More”.

When the home screen selection operation portion 30a is tapped, the home screen illustrated in FIG. 3A is displayed on the display 26. When the solo play selection operation portion 30b is tapped, various types of setting screens are displayed. Then, when setting is performed on the setting screens, a card battle game against a computer is started. When the multiplay selection operation portion 30c is tapped, various types of setting screens are displayed. Then, when setting is performed on the setting screens, a card battle game through communication match-up against another player is started.

When the card setting screen selection operation portion 30d is tapped, the card setting screen illustrated in FIG. 3B is displayed on the display 26. On the card setting screen, editing a deck, displaying a list of cards, resolving or creating a card, and the like, which will be described below, can be performed. When the shop screen selection operation portion 30e is tapped, a shop screen is displayed on the display 26. On the shop screen, a card can be acquired through lottery by consuming in-game currency or an item. When the menu screen selection operation portion 30f is tapped, a menu screen is displayed on the display 26. On the menu screen, game settings and various types of information can be confirmed. In the menu bar 30, the selection operation portion corresponding to each screen is to be highlighted so that the screen being displayed on the display 26 can be identified.

A header display region 31 is provided at the upper left of the home screen illustrated in FIG. 3A. In the header display region 31, a player name, a player icon, and a battle point (BP) associated with a player ID are displayed. Note that the battle points can be acquired when the player wins the card battle game through communication match-up against another player, and are subtracted when the player loses the card battle game through communication match-up against another player.

A home menu 32 is displayed at the right end of the home screen. The home menu 32 includes a gift screen selection operation portion 32a denoted by “Gift”, an information screen selection operation portion 32b denoted by “Information”, a mission screen selection operation portion 32c denoted by “Mission”, and a guild screen selection operation portion 32d denoted by “Guild”.

When the gift screen selection operation portion 32a is tapped, for example, a gift screen (not illustrated) for displaying an item distributed from the administrator is displayed on the display 26. When the information screen selection operation portion 32b is tapped, an information screen (not illustrated) for displaying update information, maintenance information, and the like is displayed on the display 26. When the mission screen selection operation portion 32c is tapped, a mission screen (not illustrated) for displaying a preset mission is displayed on the display 26. When the guild screen selection operation portion 32d is tapped, a guild screen related to a guild (group) constituted by a plurality of players is displayed on the display 26.

The card setting screen illustrated in FIG. 3B is displayed on the display 26 when the card setting screen selection operation portion 30d is tapped. In the card setting screen, a deck edit tab 33a and a card list creation tab 33b are displayed. When the deck edit tab 33a is tapped, a deck selection screen illustrated in FIG. 3C is displayed. In the deck selection screen, a list of decks edited by the player is displayed. The player can edit a deck name when editing a deck. In the deck selection screen, a deck name is displayed on an icon corresponding to each deck.

A deck creation tab 34 denoted by “Create New” is displayed in the deck selection screen. When the player taps the deck creation tab 34, a deck edit screen illustrated in FIG. 3D is displayed on the display 26 so that a new deck can be edited.

In the deck edit screen, a plurality of empty spaces are displayed in the upper row, and cards possessed by the player (hereinafter referred to as possessed cards) are displayed in the lower row. In the deck edit screen, as illustrated in FIG. 4A, by sliding a possessed card displayed in the lower row to the upper row, the slid possessed card is arranged in an empty space in the upper row. In this manner, on the deck edit screen, the possessed cards arranged in the upper row are in a temporarily registered state.

When a save tab 35 denoted by “Save” provided in the deck edit screen is tapped, deck information is stored. A deck ID is given to the deck information, and card group information by which all the temporarily registered possessed cards can be identified is stored in association with the deck ID. Although not illustrated, a screen for editing a deck name is displayed when the save tab 35 is tapped. Upon completion of the editing of the deck name, the deck name and an icon displayed in the deck selection screen or the like are stored in association with the deck ID together with the card group information.

The deck edit screen is also displayed as illustrated in FIG. 4A when any icon is tapped on the deck selection screen illustrated in FIG. 3C. However, in this case, cards constituting the deck selected on the deck selection screen are displayed in the upper row, and possessed cards are displayed in the lower row. In this case, the player can change a card displayed in the upper row to a possessed card displayed in the lower row.

In the card battle game, a prescribed number of cards (for example, 40 cards) are used. Thus, on the deck edit screen, deck information including card group information of the prescribed number of cards is usually stored when the prescribed number of possessed cards are temporarily registered and then the save tab 35 is tapped by the player's operation. The deck information can be saved even when the number of temporarily registered cards is less than the prescribed number or exceeds the prescribed number, but such deck information cannot be used in the card battle game.

When the card list creation tab 33b is tapped on the card setting screen, a card list screen illustrated in FIG. 4B is displayed on the display 26. The card list screen includes a possessed card tab 36a, a creation mode tab 36b, and a possessed coin display field 36c at the bottom of the display 26. The possessed card tab 36a and the creation mode tab 36b are configured to receive a tap operation by the player. The possessed card tab 36a and the creation mode tab 36b are also displayed on a card creation screen. When the possessed card tab 36a is tapped, the card list screen illustrated in FIG. 4B is displayed, and when the creation mode tab 36b is tapped, the card creation screen illustrated in FIG. 4C is displayed. In the possessed coin display field 36c, the number of coins (the number of possessed coins) which are in-game currency possessed by the player is displayed.

As illustrated in FIG. 4B, the possessed cards of the player and the number of the possessed cards are displayed on the card list screen. In the card list screen, cards not possessed by the player may be displayed. In addition, as illustrated in FIG. 4C, all cards to be provided are displayed on the card creation screen regardless of whether the player possesses them. However, while cards possessed by the player are displayed in color, cards not possessed by the player are displayed in gray-out (indicated by broken lines in FIG. 4C). Thus, the player can easily recognize whether cards are in the player's possession.

When each card is tapped on the card list screen and the card creation screen, a card detail screen is displayed as illustrated in FIG. 4D. The card detail screen displays various types of information related to the tapped card, and includes a resolution tab 37a and a creation tab 37b. The number of coins to be earned is displayed in the resolution tab 37a. When the resolution tab 37a is tapped, the currently selected card is resolved, and the player can acquire the number of coins to be earned displayed in the resolution tab 37a. When a card is resolved, the number of the possessed cards decreases.

The number of coins to be consumed is displayed in the creation tab 37b. When the creation tab 37b is tapped, the selected card can be created by consuming the number of coins to be consumed displayed in the creation tab 37b. When a card is created, the number of the possessed cards increases. That is, by tapping the creation tab 37b, the player can exchange the possessed coins for a card. Such a card creation function can be executed regardless of whether the player possesses a card. That is, the player can perform card creation for both cards possessed and cards not possessed.

Provided cards may include cards that can be created and cards that cannot be created, or all the provided cards may be cards that can be created. Further, a card in which a creatable time and an uncreatable time are set may be included.

In addition, as will be described in detail below, some cards can evolve during the card battle game. In the present embodiment, “evolution” means that a card selected by a player is changed to another card. When a card evolves, the performance of the card is enhanced.

The card detail screen includes a first button 37c and a second button 37d. On the card detail screen of an evolvable card, the first button 37c is enabled. Although not illustrated, when the first button 37c is tapped, the details of the card after evolution are displayed on the card detail screen.

Evolvable cards include specific cards to be described below. A specific card is associated with a plurality of types of special cards as cards after evolution. In the card battle game, when a specific condition is satisfied, the player can select any one of the plurality of types of special cards as a card after evolution. When the specific condition is not satisfied, the card evolves into a predetermined card like other evolvable cards.

On the card detail screen of a specific card, the second button 37d is enabled. Although not illustrated, when the second button 37d is tapped, the details of a special card associated with the specific card are displayed on the card detail screen. At this time, the plurality of types of special cards are switchably displayed on the card detail screen. In addition, when the first button 37c is tapped on the card detail screen of the specific card, the details of a card into which the specific card evolves when the specific condition is not satisfied are displayed.

The card detail screen is displayed both during the card battle game and outside the card battle game. During the card battle game, the card detail screen can be displayed not only for a player's own card but also for an opponent's card. Accordingly, during the card battle game, the player can grasp to what kind of card the opponent can evolve.

Next, the card battle game will be described. Hereinafter, an outline of the card battle game will be described, and then the details of cards and the details of the card battle game will be described in sequence. Here, the card battle game in which a player plays a match against another player will be described. In the following description, another player against whom the match is played is referred to as an opponent.

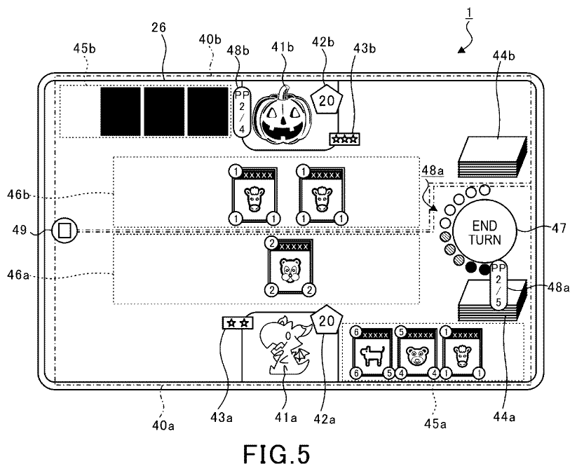

FIG. 5 is a diagram illustrating an example of a card battle game screen. When the multiplay selection operation portion 30c of the menu bar 30 is tapped, various types of setting screens are displayed. Then, when setting is performed on the setting screens, a card battle game is started. During the execution of the card battle game, a battle screen illustrated in FIG. 5 is displayed on the display 26.

The battle screen is divided into a player display region 40a in which cards, information, and the like of the player are displayed and an opponent display region 40b in which cards, information, and the like of the opponent are displayed. A leader 41a of the player is displayed at the lower center of the player display region 40a, and a physical strength 42a and an evolution point 43a of the leader 41a of the player are displayed in the vicinity of the leader 41a of the player.

Similarly, a leader 41b of the opponent is displayed at the upper center of the opponent display region 40b, and a physical strength 42b and an evolution point 43b of the leader 41b of the opponent are displayed in the vicinity of the leader 41b of the opponent. Note that the physical strength 42a of the leader 41a of the player and the physical strength 42b of the leader 41b of the opponent are set to 20 as initial values.

In the player display region 40a, a deck region 44a of the player is provided at the right end, a hand region 45a of the player is provided at the lower right, and an area 46a of the player is provided at the center. In the deck region 44a, cards of the player which are not in use are placed in a face-down state, that is, in an unrecognizable state. In the hand region 45a, cards in the player's hand are arranged so as to be recognizable to the player. In the area 46a, a card or the like taken out from the hand region 45a is placed so as to be recognizable to the player.

Similarly, in the opponent display region 40b, a deck region 44b of the opponent is provided at the right end, a hand region 45b of the opponent is provided at the upper left, and an area 46b of the opponent is provided at the center. In the deck region 44b, cards of the opponent which are not in use are placed in a face-down state. In the hand region 45b, cards in the opponent's hand are arranged so as to be unrecognizable to the player, that is, in a face-down state. In the area 46b, a card or the like taken out from the hand region 45b is placed so as to be recognizable to the player.

At the upper right of the player display region 40a, a turn end button 47 that receives tapping by the player and a play point display portion 48a that displays play points (PP) of the player are provided. In the play point display portion 48a, the maximum play point in the current turn is displayed in the denominator, and a usable play point is displayed in the numerator. In addition, in the play point display portion 48a, the maximum play point and the usable play point are distinguishably displayed in a circle display mode. In the vicinity of the leader 41b in the opponent display region 40b, a play point display portion 48b that displays play points of the opponent is provided.

A battle log button 49 is provided at the left end of the battle screen. The battle log button 49 is provided so as to be capable of receiving a tap operation by the player. When the battle log button 49 is tapped, a battle log is displayed so as to be superimposed on the battle screen.

The card battle game according to the present embodiment is a match-up game between two persons, and cards to be in a player's hand are randomly distributed from a deck selected by the player. Similarly, cards to be in the opponent's hand are randomly distributed from a deck selected by the opponent. In the card battle game, the player's turn and the opponent's turn are alternately repeated. In each turn, a card randomly selected from the deck is added to the hand.

In the player's turn, the player selects a follower card or an amulet card, which will be described below, from the cards arranged in the hand region 45a of the player, and sends the selected card to the area 46a, or uses a spell card to activate a predetermined effect, in accordance with a predetermined rule. Hereinafter, sending a follower card or an amulet card arranged in the hand region 45a or 45b to the area 46a or 46b, and using a spell card arranged in the hand region 45a or 45b to activate a predetermined effect, that is, moving a card arranged in the hand region 45a or 45b to another region, is referred to as “play”.

In the card battle game, the physical strengths 42a and 42b are set for the leader 41a of the player and the leader 41b of the opponent, respectively, and whichever party first reduces the physical strength 42a or 42b of the other party to 0 by an attack with a card or the like wins. Next, the details of cards used in the card battle game of the present embodiment will be described.

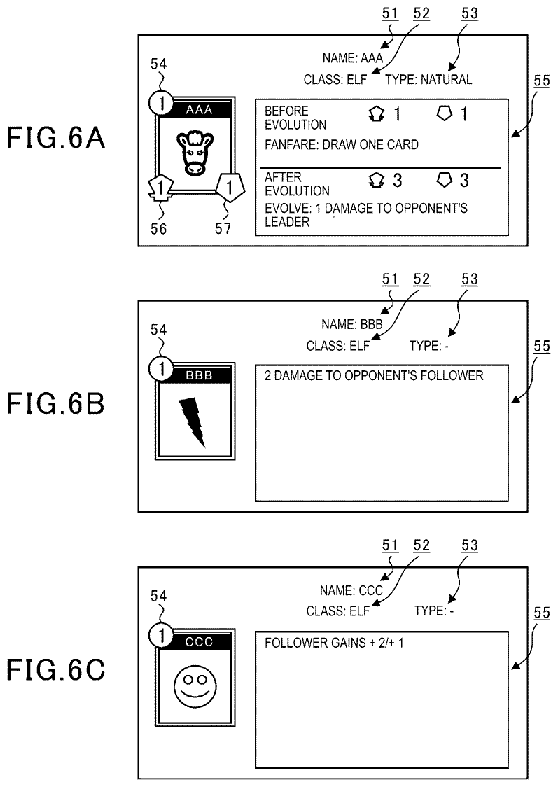

FIG. 6A is a diagram illustrating an example of a follower card. FIG. 6B is a diagram illustrating an example of a spell card. FIG. 6C is a diagram illustrating an example of an amulet card. Each card used in the card battle game of the present embodiment is classified into any one of card types of a follower card, a spell card, and an amulet card.

As illustrated in FIG. 6A to FIG. 6C, a name 51, a class 52, a type 53, and a cost 54 are set for each card regardless of the type of the card. The name 51 is uniquely set for each card. That is, the name 51 can also be referred to as a card name. The class 52 includes a plurality of classes, and each card is classified into one of the classes. The type 53 includes a plurality of types, and there are cards that are classified into any of the types and cards that are not classified into any type. The cost 54 indicates play points necessary for playing, and a card can be played by consuming the play points corresponding to the cost.

In the card battle game, the follower card illustrated in FIG. 6A is a card that can attack the leader 41b of the opponent and a follower card placed in the area 46b of the opponent. The name 51, The class 52, the type 53, the cost 54, an ability 55, an attack power 56, and a physical strength 57 are set for each follower card. The attack power 56 indicates the amount of damage given to the leader 41b of the opponent or a follower card placed in the area 46b of the opponent that is a target of attack when the follower card attacks. When a follower card is damaged, the physical strength 57 is reduced by the amount of the damage received, and when the physical strength 57 becomes 0, the follower card is destroyed. The destroyed card is hidden from the area 46a and sent to a graveyard (not illustrated). However, a state of being hidden from the area 46b includes a state of banishing without being sent to the graveyard unlike the destruction.

Further, a follower card can evolve by consuming the evolution point 43a or 43b. In the evolved follower card, the attack power 56 and the physical strength 57 are increased, or a predetermined ability 55 is added. That is, when a follower card evolves, the performance (the ability 55, the attack power 56, and the physical strength 57) of that card is enhanced.

In the spell card illustrated in FIG. 6B, the name 51, the class 52, the type 53, the cost 54, and the ability 55 are set. When a spell card is played, the ability 55 (effect) is activated and the spell card is destroyed. That is, spell cards are cards that cannot stay in the area 46a or 46b.

In the amulet card illustrated in FIG. 6C, the name 51, the class 52, the type 53, the cost 54, and the ability 55 are set. When an amulet card is played, the amulet card stays in the area 46a and the ability 55 thereof is activated.

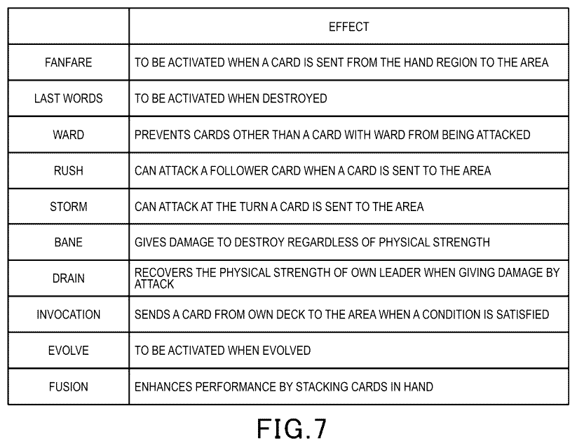

FIG. 7 is a diagram illustrating examples of the abilities 55. Note that abilities 55 illustrated in FIG. 7 are only examples, and other abilities 55 may be provided, or some of the abilities 55 are not necessarily provided. Here, the description will be made on the assumption that cards are the player's cards, but the same description applies to the opponent's cards.

As illustrated in FIG. 7, the abilities 55 include Fanfare, Last Words, Ward, Rush, Storm, Bane, Drain, Invocation, Evolve, Fusion, and the like. Fanfare is an ability to activate an effect described after “Fanfare” when a card is sent from the hand region 45a to the area 46a (when the card is played). For example, in the example of the follower card illustrated in FIG. 6A, when the follower card is sent to the area 46a, the effect of “drawing one card” is activated, whereby one card is determined by drawing from the cards placed in the deck region 44a, and the determined card is arranged in the hand region 45a.

Last Words is an ability to activate an effect described after “Last Words” when the card is destroyed. Ward is an ability to prevent, when a card with Ward is placed in the area 46a, the opponent from attacking a card other than the card with Ward. Rush is an ability to attack a follower card of the opponent on the same turn a card with Rush is sent to the area 46a.

Storm is an ability to attack a follower card and the leader 41b of the opponent on the same turn a card with Storm is sent to the area 46a. Bane is an ability to destroy a follower card of the opponent regardless of the physical strength of the follower card of the opponent when a card with Bane attacks and damages the follower card of the opponent. Drain is an ability to recover the physical strength 42a of the leader 41a of the player by the amount of damage given to a follower card or the leader 41b of the opponent in the player's turn.

Invocation is an ability to directly send a card from the deck region 44a to the area 46a when a condition set in advance is satisfied. Evolve is an ability to activate an effect described after “Evolve” when a follower card evolves. Fusion is an ability given to a base card serving as a fusion source, and is an ability to enhance the card by fusing a card arranged in the hand region 45a satisfying a condition set in advance as a material card. Note that, a plurality of abilities 55 may be set in an overlapping manner, or no ability 55 may be set, for one card.

In the present embodiment, a deck is edited by combining follower cards, spell cards, and amulet cards, and a card battle game is performed using the edited deck. Hereinafter, the details of the card battle game will be described.

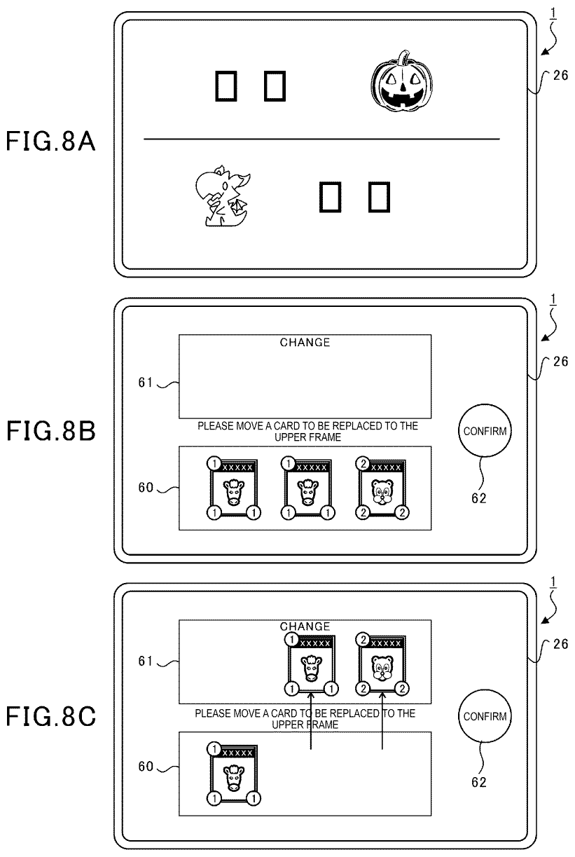

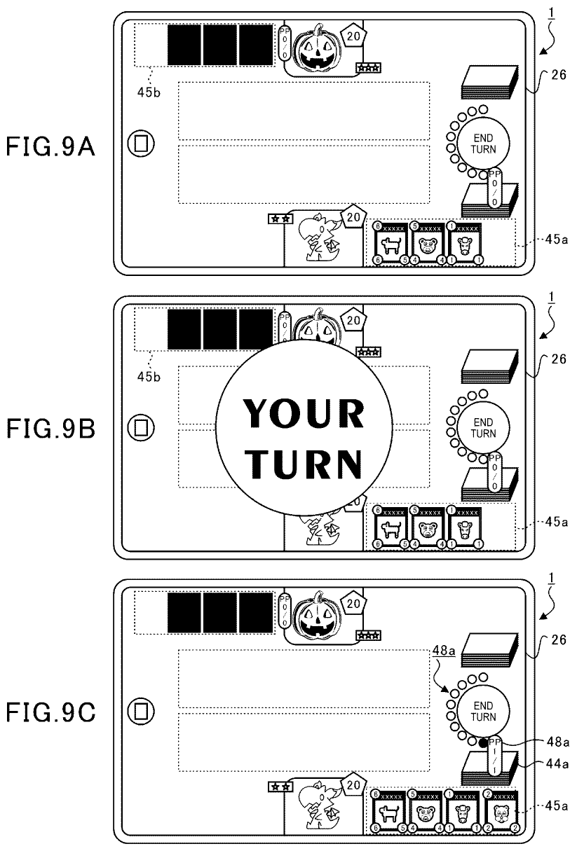

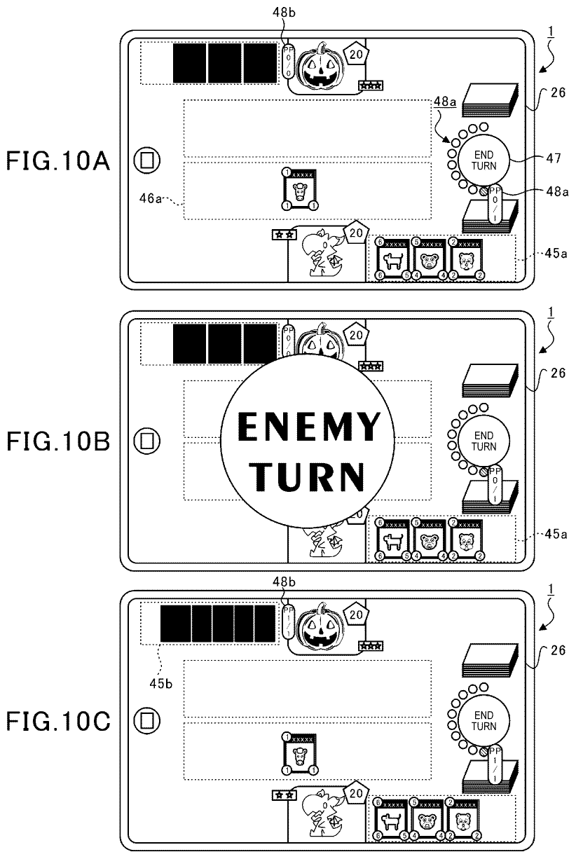

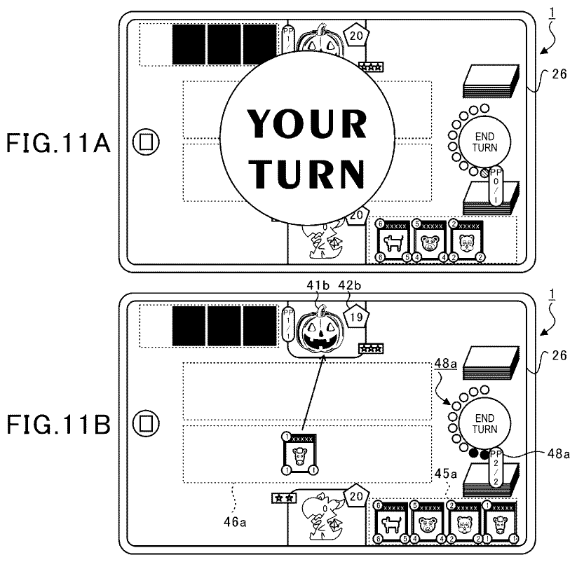

FIG. 8A is a first diagram illustrating an example of the transition of the card battle screen. FIG. 8B is a second diagram illustrating an example of the transition of the card battle screen. FIG. 8C is a third diagram illustrating an example of the transition of the card battle screen. FIG. 9A is a fourth diagram illustrating an example of the transition of the card battle screen. FIG. 9B is a fifth diagram illustrating an example of the transition of the card battle screen. FIG. 9C is a sixth diagram illustrating an example of the transition of the card battle screen. FIG. 10A is a seventh diagram illustrating an example of the transition of the card battle screen. FIG. 10B is an eighth diagram illustrating an example of the transition of the card battle screen. FIG. 10C is a ninth diagram illustrating an example of the transition of the card battle screen. FIG. 11A is a tenth diagram illustrating an example of the transition of the card battle screen. FIG. 11B is an eleventh diagram illustrating an example of the transition of the card battle screen.

When the card battle game is started, deck information to be used is transmitted from the player terminal 1 to the server 100. Deck information is also transmitted from the player terminal 1 of the opponent to the server 100. The server 100 randomly determines the first party who plays first and the second party who plays second and randomly assigns indices (e.g., numbers 1 to 40) to all cards indicated in the deck information. The server 100 also determines three initial candidate cards and three replacement candidate cards from the cards indicated in the deck information.

Then, the server 100 transmits, to the player terminal 1, initial information including play order information that indicates the first party and the second party, index information that indicates indices of the cards of the player, and replacement information that indicates the initial cards and the replacement candidate cards. In the player terminal 1, when the card battle game is started, whether the player is the first party or the second party is displayed on the display 26 as illustrated in FIG. 8A based on the play order information. Subsequently, in the player terminal 1, based on the replacement information, three initial candidate cards are arranged in an initial card display region 60, and a replacement display region 61 for displaying a card to be replaced is displayed on the display 26 as illustrated in FIG. 8B.

When there is a card to be replaced among the initial candidate cards, the player moves the card to be replaced to the replacement display region 61 by a slide operation as illustrated in FIG. 8C. Then, when a determination button 62 is tapped by the player, the card moved to the replacement display region 61 is returned to the deck region 44a, the initial candidate cards that are not replaced as well as the replacement candidate card the number of which corresponds to the number of replaced initial candidate cards are determined as the initial cards, and initial card information indicating the determined initial cards is transmitted to the server 100.

The server 100 also receives initial card information from the player terminal 1 of the opponent. Upon receiving the initial card information from both of the player and the opponent, the server 100 transmits, to the player terminal 1 of the player, number-of-cards information indicating only the number of cards included in the initial card information of the opponent. Similarly, upon receiving the initial card information from both of the player and the opponent, the server 100 transmits number-of-cards information indicating only the number of cards included in the initial card information of the player to the player terminal 1 of the opponent.

Upon receiving the number-of-cards information, the player terminal 1 displays the battle screen on the display 26 as illustrated in FIG. 9A. At this time, the determined initial cards are arranged in the hand region 45a in a recognizable manner, and three cards are arranged in the hand region 45b in an unrecognizable manner based on the received number-of-cards information of the opponent.

Subsequently, when the player is the first party, the player terminal 1 displays an image showing “YOUR TURN” that announces the player's turn on the display 26 as illustrated in FIG. 9B, and then determines one index of a card in the deck region 44a by drawing. That is, here, one card in the deck region 44a is determined by drawing. Then, as illustrated in FIG. 9C, the player terminal 1 places the card determined by drawing in the hand region 45a and transmits the card information to the server 100. Further, the player terminal 1 adds 1 to the play point and updates and displays the play point display portion 48a (here, the play point is set to 1).

Subsequently, as illustrated in FIG. 10A, for example, when the player selects a follower card with cost 1 from the cards arranged in the hand region 45a and sends it to the area 46a by a slide operation, the play point is reduced by 1 and the play point display portion 48a is updated and displayed. Here, when the follower card sent to the area 46a has the ability 55 and an activation condition is satisfied, the ability 55 whose activation condition is satisfied is activated.

In addition, the player terminal 1 transmits the card information indicating the card sent to the area 46a to the server 100. Upon receiving the card information, the server 100 transmits the received card information to the player terminal 1 of the opponent. Accordingly, in the player terminal 1 of the opponent, the card indicated by the card information is placed in the area 46b of the opponent, and the play point display portion 48b of the opponent is updated and displayed.

Subsequently, when the turn end button 47 is tapped by the player, the player terminal 1 transmits turn end information indicating that the turn has ended to the server 100. Note that, in the player terminal 1, when a card whose ability 55 is to be activated on the condition that the turn ends is placed in the area 46a or 46b, the ability 55 of that card is activated. Upon receiving the turn end information, the server 100 transmits, to the player terminal 1 of the opponent, turn start information indicating that the player's turn has ended and causing the opponent's turn to start, thereby causing the player terminal 1 of the opponent to start its turn.

Then, the player terminal 1 of the player displays an image showing “ENEMY TURN” that announces the opponent's turn on the display 26 as illustrated in FIG. 10B. Subsequently, when the card information of a card determined by drawing in the player terminal 1 of the opponent is transmitted to the server 100 and the number-of-cards information is received from the server 100, the card is arranged in the hand region 45b of the player terminal 1 in an unrecognizable manner based on the number-of-cards information as illustrated in the FIG. 10C. Note that while one card is generally determined by drawing at the start of a turn, two cards are determined by drawing only at the first turn of the second party. In addition, the play point of the opponent increases by 1 and the play point display portion 48b is updated and displayed in the player terminal 1.

Subsequently, when the opponent ends the opponent's turn without playing any card from the hand region 45b and turn start information is received from the server 100, the player terminal 1 displays the image showing “YOUR TURN” that announces the player's turn on the display 26 as illustrated in FIG. 11A, and then determines one index of a card in the deck region 44a by drawing. Then, the card determined by drawing is placed in the hand region 45a and the card information of the determined card is transmitted to the server 100. Further, the player terminal 1 adds 1 to the play point and updates and displays the play point display portion 48a (here, the play point is set to 2).

Then, when the player slides a follower card placed in the area 46a to the leader 41b of the opponent, it is determined that the leader 41b of the opponent is attacked by the follower card, and the physical strength 42b of the leader 41b of the opponent is reduced by the attack power 56 of the follower card. In addition, the player terminal 1 transmits attack information indicating the follower card that has attacked and a follower card or the leader 41b that has been attacked to the server 100. Upon receiving the attack information, the server 100 transmits the attack information to the player terminal 1 of the opponent.

As described above, the player's turn and the opponent's turn are alternately repeated, and every time the player and the opponent play a card or make an attack, the information thereof is transmitted to the server 100, whereby the card battle game progresses. Then, when the physical strength 42a of the leader 41a of the player or the physical strength 42b of the leader 41b of the opponent becomes 0, winning or losing is decided, and the card battle game is ended.

Next, the evolution of a follower card will be described. In the card battle game of the present embodiment, it is possible to evolve a follower card by consuming the evolution point 43a or 43b in and after the fifth turn of the first party and in and after the fourth turn of the second party. For the evolution points 43a and 43b, 2 points are given to the first party, and 3 points are given to the second party.

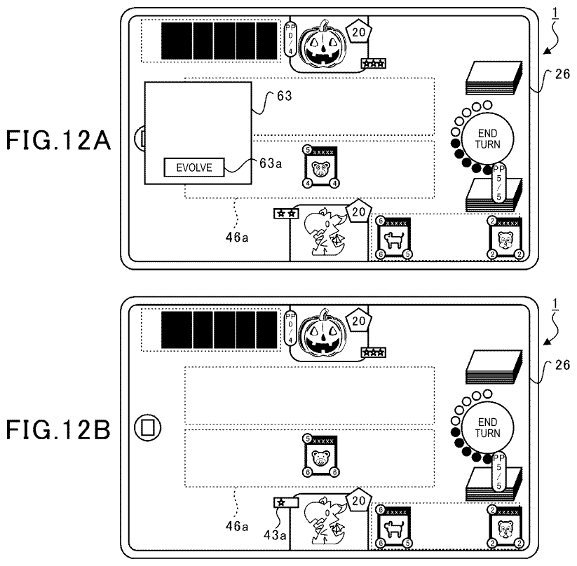

FIG. 12A is a first diagram illustrating an example of the battle screen at the time of evolution. FIG. 12B is a second diagram illustrating an example of the battle screen at the time of evolution. For example, it is assumed that a follower card that has not evolved is placed in the area 46a at the fifth turn of the first party as illustrated in FIG. 12A. At this time, when the follower card placed in the area 46a is tapped, a card detail tab 63 is displayed on the display 26.

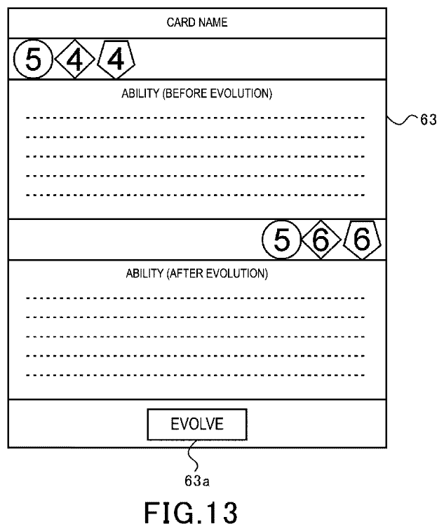

FIG. 13 is a diagram illustrating an example of the card detail tab 63. In the card detail tab 63, the ability 55 of the tapped card is displayed, and an evolution button 63a is displayed. Note that the evolution button 63a is displayed only in the card detail tabs 63 of follower cards, and the evolution button 63a is not displayed in the card detail tabs 63 of spell cards and amulet cards. When evolution is possible, the evolution button 63a functions as an operation portion that receives tapping by the player. Thus, in the present embodiment, only follower cards are set as cards that can evolve.

When the follower card tapped by the player is evolvable, the ability 55 before evolution is displayed at an upper part of the card detail tab 63 as illustrated in FIG. 13. The ability 55 after evolution is displayed at a lower part of the card detail tab 63.

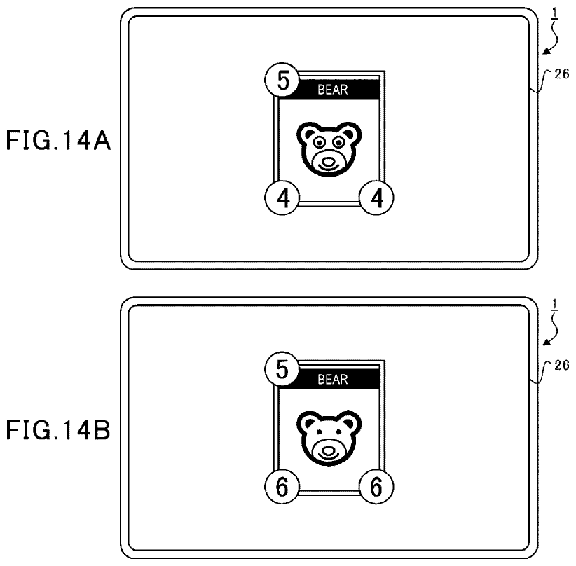

FIG. 14A is a first diagram illustrating an example of an evolutionary animation. FIG. 14B is a second diagram illustrating an example of the evolutionary animation. When the evolution button 63a of the card detail tab 63 is tapped, an evolutionary animation is displayed. In the evolutionary animation, after the card before evolution is displayed as illustrated in FIG. 14A, an animation image (not illustrated) in which the card evolves is displayed. Then, the card after evolution is displayed as illustrated in FIG. 14B.

In this way, when the display of the evolutionary animation ends, the evolution point 43a is reduced and displayed as illustrated in FIG. 12B, and the card after evolution is displayed in the area 46a. At this time, the attack power 56 and the physical strength 57 of the evolved card increase. In addition, when the follower card has “Evolve” as the ability 55, the ability is activated. Further, the player terminal 1 transmits evolution information indicating the evolved follower card to the server 100. Upon receiving the evolution information, the server 100 transmits the evolution information to the player terminal 1 of the opponent. In the player terminal 1 of the opponent, the fact that the card has evolved and the card after evolution can be grasped based on the evolution information received.

Here, in the present embodiment, the plurality of types of cards include specific cards. A specific card is an evolvable follower card, and is a card associated with a plurality of types of special cards as cards after evolution. When the specific card satisfies a specific condition, the player can select any one special card from among the plurality of types of special cards as a card after evolution.

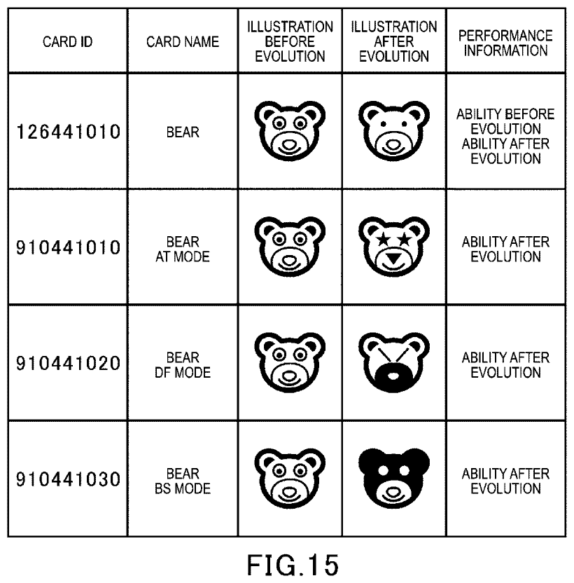

FIG. 15 is a diagram illustrating examples of specific cards and special cards. In the present embodiment, every card is associated with a card ID, a card name, an illustration, and card performance information such as the ability 55. Here, as illustrated in the top row of FIG. 15, a specific card having a card ID of “126441010” and a card name of “Bear” is provided. This specific card is an evolvable card. The evolvable card is associated with an illustration before evolution and an illustration after evolution as the illustration.

The performance information associated with the specific card includes the ability 55 before evolution and the ability 55 after evolution. In the card detail tab 63 displayed when the specific card before evolution is tapped, the ability 55 before evolution associated with the specific card is displayed in the upper row, and the ability 55 after evolution associated with the specific card is displayed in the lower row.

In the present embodiment, as illustrated in FIG. 15, three types of special cards having card names of “Bear AT mode”, “Bear DF mode”, and “Bear BS mode” are provided. These special cards are associated with the specific card, and the first three digits of the card ID are “910” indicating that these cards are special cards. In addition, in all the special cards, the values of the 4th to 6th digits of the card ID are the same as the values of the 4th to 6th digits of the card ID of the specific card. In this way, the specific card and the special cards are associated with each other by assigning the same values to the 4th to 6th digits of the card IDs. When a plurality of specific cards are provided, special cards associated with the respective specific cards are different from each other between all the specific cards.

The three special cards are associated with the same illustration as the specific card as the illustration before evolution. On the other hand, the three special cards are associated with illustrations different in display mode from the specific card as the illustration after evolution. In addition, the illustrations after evolution associated with the three special cards are also different in display mode from each other.

Further, each of the three special cards is associated with the performance information including the ability 55 after evolution. The performance information associated with each of the special cards is different from the performance information associated with the specific card. The performance information associated with the respective three special cards is also different from each other. However, one of the illustrations after evolution and the performance information after evolution may be the same between the special cards.

As described above, in the present embodiment, a specific card is associated with an illustration and performance information before evolution and an illustration information evolution. The and performance after illustration and the performance information associated with the specific card are different before and after evolution. In addition, a plurality of special cards are associated with one specific card. Each of the special cards is associated with an illustration and performance information after evolution different from those of the corresponding specific card.

A specific condition for evolution is set in advance for a specific card. Here, the fact that predetermined card has been displayed (placed) in the area 46a is set as the specific condition. The predetermined card is a card other than the specific card, and is a part of all the cards, here.

In a case where the specific condition is not satisfied, that is, where the predetermined card is not displayed in the area 46a, when the evolution button 63a of the card detail tab 63 of the specific card is tapped, the illustration and the performance of the specific card evolve. Specifically, in this case, the specific card is not changed to another card, but the illustration and the performance of the same specific card are changed by evolution from those before evolution to those after evolution.

On the other hand, in a case where the specific condition is satisfied, that is, where the predetermined card is displayed in the area 46a, when the evolution button 63a of the card detail tab 63 of the specific card is tapped, the player can select any one of the three special cards.

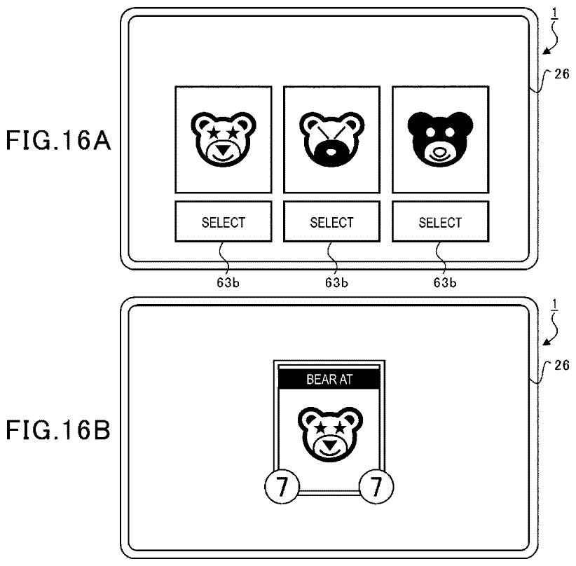

FIG. 16A is a diagram illustrating an example of a special card selection screen. FIG. 16B is a third diagram illustrating an example of the evolutionary animation. In a case where the specific condition is satisfied, when the evolution button 63a of the card detail tab 63 of the specific card is tapped, the special card selection screen illustrated in FIG. 16A is displayed. On the special card selection screen, the three special cards associated with the specific card are displayed in a recognizable manner. Further, a selection operation portion 63b is displayed for each special card.

When the selection operation portion 63b is tapped, the specific card evolves (changes) to the special card selected by the player. In this case, similarly to the above, the evolutionary animation is displayed, and a notification that the specific card has evolved to the special card selected by the player appears as illustrated in FIG. 16B.

In this way, in the present embodiment, when the specific condition is satisfied, the player can evolve a specific card into a special card. Thus, in order to evolve a specific card into a special card, the player needs to progress the game so as to satisfy the specific condition, and therefore strategic performance is required. In addition, a plurality of special cards are provided and have different performances. Therefore, it is necessary to determine to which special card to evolve while watching the situation of the game, and thus a higher degree of strategic performance is required. As described above, according to the present embodiment, a higher degree of strategic performance is required, and thus the attractiveness of the game is improved.

Here, a case in which a specific card is associated with illustrations and performance information before and after evolution has been described. However, a specific card may be associated with an illustration and performance information before evolution, and need not be associated with an illustration and performance information after evolution. In that case, for example, it is suitable to provide a dedicated evolved card associated with an illustration and performance information after evolution separately from specific cards and special cards. When the specific condition is not satisfied, a specific card evolves to a dedicated evolved card.

In the present embodiment, both the illustration and the performance indicated in a specific card are changed before and after the evolution of the specific card. However, only one of the illustrations and the performance indicated in the card may be changed.

In the present embodiment, a case in which the fact that a predetermined card has been displayed in the area 46a is set as the specific condition has been described. However, the specific condition is not limited thereto. For example, one or more of the following conditions may be set as the specific condition: the player or the opponent possesses a predetermined card; a predetermined card is destroyed; a predetermined card is displayed in the area 46b of the opponent; the opponent possesses a predetermined card; and the number of remaining cards is equal to or less than a predetermined number or equal to or more than the predetermined number.

Alternatively, for example, the fact that equal to or more than a predetermined number of follower cards of the player have left the area 46a during the card battle game may be set as the specific condition. In that case, “leaving the area 46a” includes either one or both of sending of a card to the graveyard due to destruction of the card and banishing of a card. In addition, not only follower cards but also predetermined cards other than follower cards may be included in the count of cards that have left the area 46a for determining whether the specific condition is satisfied.

In this manner, the specific condition may be the number of times the player or the opponent performs a predetermined operation during the card battle game or during one turn, the content of the predetermined operation, or the like. That is, the specific condition may be determined to have been satisfied when the operation input by the player or the opponent during a predetermined period or the progress status of the card battle game satisfies a condition set in advance.

In the present embodiment, an illustration and performance after evolution when the specific condition is not satisfied are different from an illustration and performance after evolution when the specific condition is satisfied. That is, the illustration and the performance after evolution are completely different between a case in which the specific condition is satisfied and a case in which the specific condition is not satisfied. However, one or both of the display mode and the performance of a special card may be different from a preset display mode or a preset performance resulting from the changing when the specific condition is not satisfied. Note that a part of the illustration or the performance after evolution may be the same between a case in which the specific condition is satisfied and a case in which the specific condition is not satisfied.

For example, cards that are to be selected when the specific condition is not satisfied may be included in cards that can be selected when the specific condition is satisfied. In that case, the player can select a card that is to be selected when the specific condition is not satisfied, regardless of whether the specific condition is satisfied. However, as in the present embodiment, when the illustration and the performance after evolution are completely different between a case in which the specific condition is satisfied and a case in which the specific condition is not satisfied, strategic performance of intentionally preventing the specific condition from being satisfied may be required, that is, a higher degree of strategic performance may be required.

In the present embodiment, a case in which a special card is provided separately from a specific card and the specific card itself is changed to the special card when the specific condition is satisfied has been described. However, for example, a plurality of patterns of one or both of the illustration and the performance after evolution may be stored in association with a specific card, and only the illustration or the performance may be changed without changing the card.

In the present embodiment, when the specific condition is satisfied, the player can select any one special card from among the plurality of special cards. However, when the specific condition is satisfied, a special card after evolution may be determined by drawing, for example. Alternatively, when the specific condition is satisfied, a special card after evolution may be determined based on the number, type, predetermined parameter, or the like of cards displayed and placed in the area 46a or 46b at that time.

In any case, in a case where a specific game medium (specific card) associated with a specific display mode and specific performance from among a plurality of game media (cards) is displayed in an arrangement region (the area 46a) and a predetermined operation input (tapping of the evolution button 63a) is performed on the specific game medium, when a specific condition set in advance (the fact that a predetermined card is displayed in the area 46a) is not satisfied, one or both of the specific display mode and the specific performance are changed to a preset display mode or a preset performance, and when the specific condition is satisfied, one or both of the specific display mode and the specific performance are changed to any of a plurality of the display modes or the performances.

Hereinafter, processing of the player terminal 1 and the server 100 for realizing the above-described card battle game, and functional units for executing the processing will be described. Note that, in the card battle game, processing related to evolution will be particularly described below, and description of other processing will be omitted.

### Functional Units of Player Terminal 1

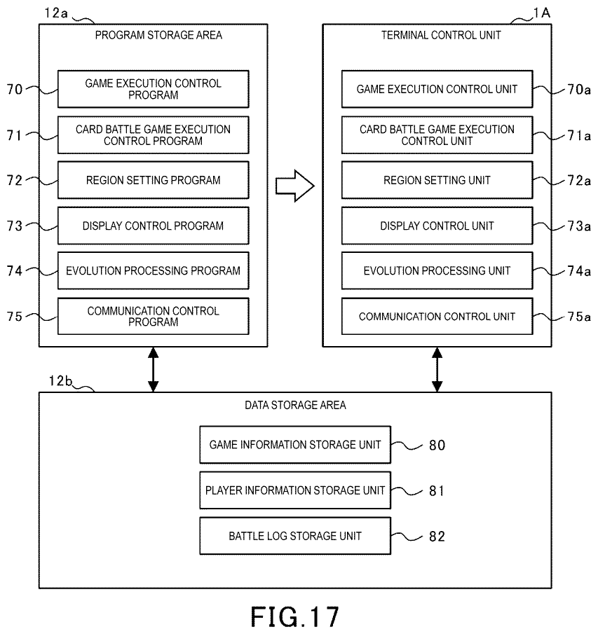

FIG. 17 is a functional block diagram of the player terminal 1. The memory 12 of the player terminal 1 is provided with a program storage area 12a and a data storage area 12b. At the start of the game, the CPU 10 stores a terminal-side game control program (module) in the program storage area 12a.

The terminal-side game control program includes a game execution control program 70, a card battle game execution control program 71, a region setting program 72, a display control program 73, an evolution processing program 74, and a communication control program 75. Note that the programs listed in FIG. 17 are merely examples, and many other programs are provided in the terminal-side game control program.

The CPU 10 runs each program stored in the program storage area 12a, and updates the data of each storage unit of the data storage area 12b. Then, the CPU 10 causes the player terminal 1 (computer) to function as a terminal control unit 1A by running each program stored in the program storage area 12a. The terminal control unit 1A includes a game execution control unit 70a, a card battle game execution control unit 71a, a region setting unit 72a, a display control unit 73a, an evolution processing unit 74a, and a communication control unit 75a.

Specifically, the CPU 10 runs the game execution control program 70 to cause the computer to function as the game execution control unit 70a. Similarly, the CPU 10 runs the card battle game execution control program 71, the region setting program 72, the display control program 73, the evolution processing program 74, and the communication control program 75 to cause them to function as the card battle game execution control unit 71a, the region setting unit 72a, the display control unit 73a, the evolution processing unit 74a, and the communication control unit 75a, respectively.

The data storage area 12b is provided with a game information storage unit 80, a player information storage unit 81, and a battle log storage unit 82 as storage units for storing data. Note that the respective storage units described above are merely examples, and many other storage units are provided in the data storage area 12b. In the game information storage unit 80, a status such as the name 51, the class 52, the type 53, the cost 54, the ability 55, the attack power 56, and the physical strength 57, and information related to an illustration are stored in association with each other for each card ID.

The game execution control unit 70a controls the progress of the entire game. The game execution control unit 70a, for example, logs in to the game in response to an operation of the player, and determines whether the game information of the entire game has been updated.

The card battle game execution control unit 71a is responsible for control to execute the card battle game. For example, the card battle game execution control unit 71a controls the progress of the card battle game based on an operation input to the player terminal 1, and stores a battle log in the battle log storage unit 82.

The region setting unit 72a sets regions in which cards are arranged in the card battle game. For example, the region setting unit 72a sets the deck regions 44a and 44b in which unused cards are arranged, the hand regions 45a and 45b as regions in which cards in hand are arranged, and the areas 46a and 46b as regions in which played cards are arranged.

The display control unit 73a performs a display control for an image displayed on the display 26 in accordance with an operation by the player and the progress of the game.

The evolution processing unit 74a performs processing of evolving a card based on the fact that the evolution button 63a or the selection operation portion 63b is operated during the card battle game.

The communication control unit 75a transmits and receives information to and from the server 100.

### Functional Units of Server 100

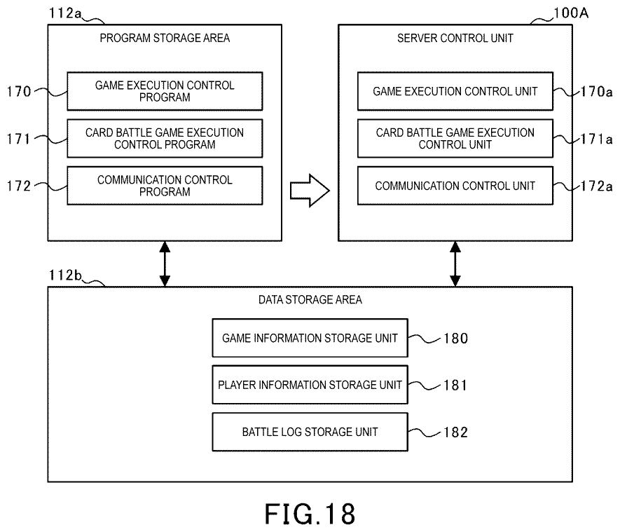

FIG. 18 is a functional block diagram of the server 100. The memory 112 of the server 100 is provided with a program storage area 112a and a data storage area 112b. In the program storage area 112a, a game execution control program 170, a card battle game execution control program 171, and a communication control program 172 are stored as a server-side game control program. Note that the programs listed in FIG. 18 are merely examples, and many other programs are provided in the server-side game control program.

The CPU 110 runs each program stored in the program storage area 112a, and updates the data of each storage unit of the data storage area 112b. Then, the CPU 110 causes the server 100 (computer) to function as a server control unit 100A by running each program stored in the program storage area 112a. The server control unit 100A includes a game execution control unit 170a, a card battle game execution control unit 171a, and a communication control unit 172a.

Specifically, the CPU 110 runs the game execution control program 170 to cause the computer to function as the game execution control unit 170a. Similarly, the CPU 110 runs the card battle game execution control program 171 and the communication control program 172 to cause them to function as the card battle game execution control unit 171a and the communication control unit 172a, respectively.

The data storage area 112b is provided with a game information storage unit 180, a player information storage unit 181, and a battle log storage unit 182 as storage units for storing data. Note that the respective storage units described above are merely examples, and many other storage units are provided in the data storage area 112b.

The game execution control unit 170a controls the progress of the entire game. For example, upon receiving login information from the player terminal 1, the game execution control unit 170a transmits player information (deck information, BP, and the like) stored in the player information storage unit 181 to the player terminal 1 via the communication control unit 172a. When the game information of the entire game is updated, the game execution control unit 170a reads out the updated game information from the game information storage unit 180 and transmits the updated game information to the player terminal 1 via the communication control unit 172a.

The card battle game execution control unit 171a performs a control for executing the card battle game, and stores a battle log in the battle log storage unit 182.

The communication control unit 172a transmits and receives information to and from the player terminal 1.

Communication Processing between Player Terminal 1 and Server 100

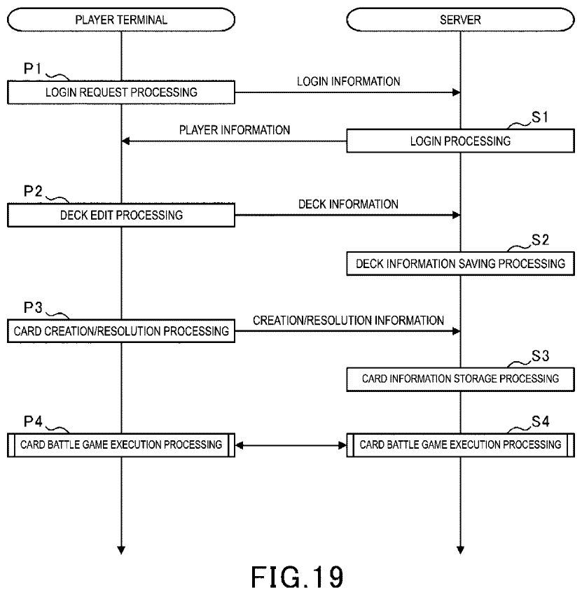

FIG. 19 is a sequence diagram illustrating processing of the player terminal 1 and the server 100. In the following description, the processing in the player terminal 1 is denoted by Pn (n is an arbitrary integer). The processing in the server 100 is denoted by Sn (n is an arbitrary integer). When an operation for starting the game is input by the player, the game execution control unit 70a of the player terminal 1 executes login request processing.

In the login request processing, login information is transmitted to the server 100 via the communication control unit 75a in accordance with the control of the game execution control unit 70a (P1). Upon receiving the login information via the communication control unit 172a, the game execution control unit 170a of the server 100 identifies the player ID associated with the login information and execute login processing (S1). Here, the game execution control unit 170a reads out the player information corresponding to the identified player ID from the player information storage unit 181, and transmits the player information to the player terminal 1 via the communication control unit 172a.

When the save tab 35 is tapped after possessed cards are temporarily registered via the deck edit screen illustrated in FIG. 3D and FIG. 4A, the game execution control unit 70a of the player terminal 1 stores deck information in the player information storage unit 81. In addition, the communication control unit 75a transmits the deck information to the server 100 (P2).

Upon receiving the deck information via the communication control unit 172a, the game execution control unit 170a of the server 100 executes deck information saving processing of storing the received deck information in the player information storage unit 181 in association with the player ID (S2).

When a card is created or resolved via the card list screen illustrated in FIG. 4B or the card creation screen illustrated in FIG. 4C, the game execution control unit 70a of the player terminal 1 stores creation/resolution information including the created or resolved card information, updated number of coins, possessed card information, and the like in the player information storage unit 81. In addition, the game execution control unit 70a executes a card creation/resolution processing of transmitting the creation/resolution information to the server 100 via the communication control unit 75a (P3).

Upon receiving the creation/resolution information via the communication control unit 172a, the game execution control unit 170a of the server 100 executes card information storage processing of updating the player information associated with the player ID stored in the player information storage unit 181 based on the received creation/resolution information (S3).

When the solo play selection operation portion 30b or the multiplay selection operation portion 30c of the menu bar 30 is tapped, various setting screens are displayed. When setting is performed on the setting screens, the card battle game execution control unit 71a transmits start information from the player terminal 1 to the server 100 via the communication control unit 75a, and executes card battle game execution processing (P4). Upon receiving the start information, the card battle game execution control unit 171a of the server 100 determines an opponent and executes card battle game execution processing (S4).

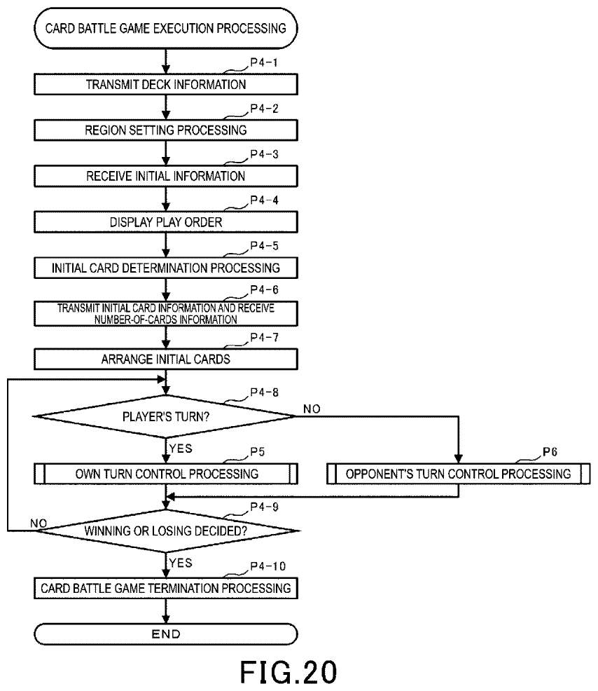

FIG. 20 is a flowchart illustrating an example of the card battle game execution processing (P4) in the player terminal 1. When the card battle game execution processing is started, the card battle game execution control unit 71a transmits the deck information used in the card battle game to the server 100 via the communication control unit 75a (P4-1).

The region setting unit 72a executes region setting processing of setting regions in which cards are arranged on the battle screen (P4-2). Here, the region setting unit 72a sets, for example, the deck regions 44a and 44b in which unused cards are arranged, the hand regions 45a and 45b in which cards in hand are arranged, and the areas 46a and 46b in which cards played from the cards displayed in the hand region 45b and the like are arranged. The region setting unit 72a also performs a setting other than the setting of the regions in which cards are arranged in the battle screen.

The display control unit 73a displays the first party and the second party on the display 26 as illustrated in FIG. 8A based on the initial information (play order information) transmitted from the server 100 (P4-4). Subsequently, the card battle game execution control unit 71a executes initial card determination processing of determining initial cards based on the initial information (replacement information) (P4-5). Here, as illustrated in FIG. 8B, the display control unit 73a arranges three initial candidate cards in the initial card display region 60 and displays the replacement display region 61 for placing cards to be replaced on the display 26 based on the initial information (play order information).

Then, when the determination button 62 is tapped by the player as illustrated in FIG. 8C, the card battle game execution control unit 71a returns the cards having moved to the replacement display region 61 to the deck region 44a and determines the initial candidate card that is not exchanged as well as replacement candidate cards the number of which corresponds to the number of replaced initial candidate cards as the initial cards. Then, the card battle game execution control unit 71a transmits initial card information indicating the initial cards to the server 100 via the communication control unit 75a, and receives the number-of-cards information of the opponent (P4-6).

Based on the regions set in P4-2, the display control unit 73a displays the battle screen on the display 26 as illustrated in FIG. 9A, and arranges the determined initial cards in the hand region 45a in a recognizable manner. In addition, the display control unit 73a arranges three cards in the hand region 45b in an unrecognizable manner based on the received number-of-cards information of the opponent (P4-7).

Subsequently, the card battle game execution control unit 71a determines whether it is the player's turn based on the play order information or the turn start information transmitted from the server 100 (P4-8). Then, when it is the player's turn (YES in P4-8), the card battle game execution control unit 71a executes own turn control processing (P5). On the other hand, when it is not the player's turn, that is, when it is the opponent's turn (NO in P4-8), the card battle game execution control unit 71a executes opponent's turn control processing (P6).

Then, when winning or losing has not been determined (NO in P4-9), the card battle game execution control unit 71a returns the processing to P4-8. When winning or losing has been decided (YES in P4-9), the card battle game execution control unit 71a executes card battle game termination processing of terminating the card battle game (P4-10) to terminate the card battle game execution processing.

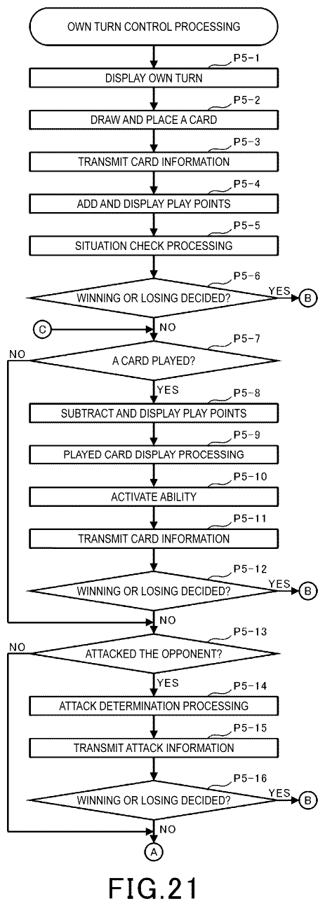

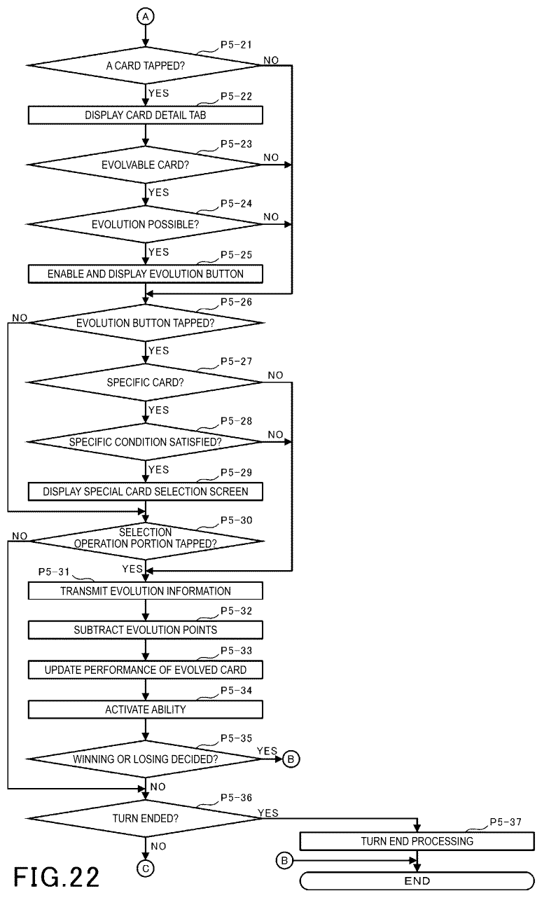

FIG. 21 is a first flowchart illustrating an example of the own turn control processing (P5) in the player terminal 1. FIG. 22 is a second flowchart illustrating an example of the own turn control processing (P5) in the player terminal 1. When the player's turn starts, the display control unit 73a displays, on the display 26, an image showing “YOUR TURN” that announces the player's turn (P5-1) as illustrated in FIG. 9B.

The card battle game execution control unit 71a determines one card in the deck region 44a by drawing (P5-2). The display control unit 73a places the determined card in the hand region 45a in a recognizable manner. The communication control unit 75a transmits the card information of the determined card to the server 100 (P5-3). The card battle game execution control unit 71a adds 1 to the play point (P5-4). The display control unit 73a updates and displays the play point display portion 48a.

The card battle game execution control unit 71a checks whether there is the ability 55 to be activated at the start of the player's turn, and when there is the ability 55 to be activated at the start of the player's turn, the card battle game execution control unit 71a executes situation check processing of activating the ability 55 (P5-5). Then, the card battle game execution control unit 71a determines, by the situation check processing, whether the physical strength 42a of the leader 41a of the player or the physical strength 42b of the leader 41b of the opponent has become 0, that is, whether winning or losing has been decided (P5-6). When winning or losing has been decided (YES in P5-6), the own turn control processing is ended, and when winning or losing has not been determined (NO in P5-6), the processing proceeds to P5-7.

When a card is played (YES in P5-7), that is, when a card arranged in the hand region 45a is sent to the area 46a, the card battle game execution control unit 71a reduces the play point by the cost 54 of the card sent to the area 46a as illustrated in FIG. 10A (P5-8). The display control unit 73a updates and displays the play point display portion 48a.

When the played card is a follower card or an amulet card, the display control unit 73a displays the card in the area 46a (P5-9). The card battle game execution control unit 71a checks the ability 55 of the played card, and when there is the ability 55 (fanfare) to be activated when the played card is sent to the area 46a, the card battle game execution control unit 71a activates the ability 55 (P5-10). The communication control unit 75a transmits the card information of the played card to the server 100 (P5-11). Then, the card battle game execution control unit 71a determines whether winning or losing has been decided (P5-12). When winning or losing has been decided (YES in P5-12), the own turn control processing is ended, and when winning or losing has not been determined (NO in P5-12), the processing proceeds to P5-13.

When the card placed in the area 46a is caused to attack a follower card or the leader 41b of the opponent by an operation of the player (YES in P5-13), the card battle game execution control unit executes attack 71a determination processing (P5-14). In the attack determination processing, the physical strength of the follower card or the leader 41b of the opponent that has been attacked is reduced, and the physical strength of the follower card that has attacked is reduced. In addition, the display control unit 73a produces a rendition for the attack.

The communication control unit 75a transmits attack information indicating the follower card that has attacked and the follower card or the leader 41b of the opponent that has been attacked to the server 100 (P5-15). Then, the card battle game execution control unit 71a determines whether winning or losing has been decided (P5-16). When winning or losing has been decided (YES in P5-16), the own turn control processing is ended, and when winning or losing has not been determined (NO in P5-16), the processing proceeds to P5-21 of FIG. 22.

The card battle game execution control unit 71a determines whether the card displayed in the area 46a has been tapped (P5-21). When the card has been tapped (YES in P5-21), the display control unit 73a displays the card detail tab 63 illustrated in FIG. 12A and FIG. 13. Here, when an evolvable card is tapped, the display control unit 73a refers to performance information before and after evolution associated with the card to display the card detail tab 63.

When a special card changed from a specific card by evolution is tapped, the display control unit 73a refers to performance information before evolution of the corresponding specific card and performance information of the current special card to display the card detail tab 63. That is, when a special card displayed in the area 46a is tapped, the performance information before evolution and the performance information after evolution are also displayed in the card detail tab 63. However, the content displayed in the card detail tab 63 is not particularly limited. For example, only the performance information after evolution may be displayed in the card detail tab 63 of a special card.

When the tapped card is an evolvable card (YES in P5-23) and can be currently evolved (YES in P5-24), the card battle game execution control unit 71a activates the evolution button 63a (P5-25). Here, when the current turn is a turn in which evolution is possible and evolution points are possessed, it is determined that evolution is possible. Here, the display control unit 73a displays the evolution button 63a in the card detail tab 63.

The card battle game execution control unit 71a determines whether the evolution button 63a displayed and activated in the card detail tab 63 has been tapped (P5-26). When the evolution button 63a has been tapped (YES in P5-26), the card battle game execution control unit 71a determines whether the tapped card is a specific card (P5-27). When the tapped card is a specific card (YES in P5-27), the card battle game execution control unit 71a determines whether the specific condition is satisfied, that is, whether a predetermined card is displayed in the area 46a (P5-28). When the specific condition is satisfied (YES in P5-28), the display control unit 73a displays the special card selection screen on the display 26 (P5-29).

When the selection operation portion 63b of the special card selection screen is tapped (YES in P5-30), when the evolution button 63a is tapped for a card other than the specific card (NO in P5-27), or when the specific condition is not satisfied when the evolution button 63a is tapped for the specific card (NO in P5-28), the communication control unit 75a transmits evolution information indicating a card to be evolved to the server 100 (P5-31).

The evolution processing unit 74a subtract 1 from the evolution point 43a (P5-32). In addition, the evolution processing unit 74a increases and updates the performance (for example, the attack power and the physical strength) of the card to be evolved (P5-33). Here, when the selection operation portion 63b is tapped, the performance is updated to the performance of the special card after evolution corresponding to the tapped selection operation portion 63b. Further, when the evolution button 63a is tapped, the performance is updated to the performance after evolution of the card selected by the player. Here, the display control unit 73a displays evolutionary animation.

The evolution processing unit 74a checks the ability 55 of the evolved card, and when there is the ability 5 (Evolve) to be activated at the time of evolution, activates the ability 55 (P5-34). Then, the evolution processing unit 74a determines whether winning or losing has been decided (P5-35). When winning or losing has been decided (YES in P5-35), the own turn control processing is ended, and when winning or losing has not been determined (NO in P5-35), the processing proceeds to P5-36.

The card battle game execution control unit 71a determines whether the player's turn has ended in response to the player's operation of the turn end button 47 (P5-36). When the player's turn has not been ended (NO in P5-36), the card battle game execution control unit 71a shifts the processing to P5-7, and when the player's turn has been ended (YES in P5-36), the card battle game execution control unit 71a executes turn end processing (5-37). Here, the ability 55 of the card placed in the area 46a is checked, and when there is the ability 55 to be activated at the end of the player's turn, the ability 55 is activated, and winning or losing is checked. The communication control unit 75a transmits the turn end information indicating that the player's turn has been ended to the server 100. When it is determined that winning or losing has been decided in P5-6, P5-12, P5-16, or P5-35 described above, the communication control unit 75a transmits win/loss information indicating that winning or losing has been decided to the server 100.

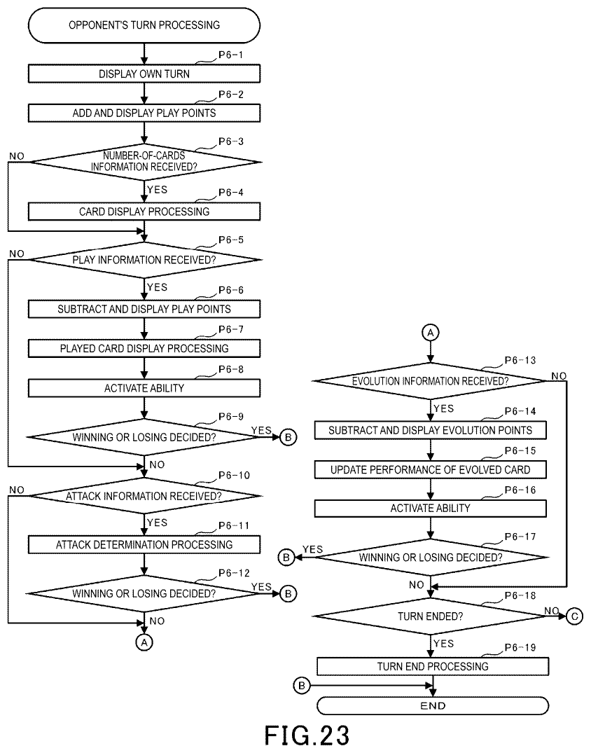

FIG. 23 is a flowchart illustrating an example of the opponent's turn control processing (P6) in the player terminal 1. When the opponent's turn starts, the display control unit 73a displays, on the display 26, an image showing “ENEMY TURN” that announces the opponent's turn (P6-1) as illustrated in FIG. 10B. The card battle game execution control unit 71a adds 1 to the play point of the opponent (P6-2). The display control unit 73a updates and displays the play point display portion 48b.

The display control unit 73a determines whether the number-of-cards information has been received via the communication control unit 75a (P6-3). When the number-of-cards information has been received (YES in P6-3), the display control unit 73a arranges cards in the hand region 45b in an unrecognizable manner based on the number-of-cards information (P6-4).

The card battle game execution control unit 71a determines whether play information has been received via the communication control unit 75a (P6-5). When the play information has been received (YES in P6-5), the card battle game execution control unit 71a reduces the play point by the cost 53 of a played card (P6-6). The display control unit 73a updates and displays the play point display portion 48b.

When the played card is a follower card or an amulet card, the display control unit 73a displays the card in the area 46b in a recognizable manner (P6-7). The card battle game execution control unit 71a checks the ability 55 of the played card, and when there is the ability 55 to be activated, the card battle game execution control unit 71a activates the ability 55 (P6-8). Then, the card battle game execution control unit 71a determines whether winning or losing has been decided (P6-9). When winning or losing has been decided (YES in P6-9), the opponent's turn control processing is ended, and when winning or losing has not been decided (NO in P6-9), the processing proceeds to P6-10.

The card battle game execution control unit 71a determines whether attack information has been received via the communication control unit 75a (P6-10). When the attack information has been received (YES in P6-10), the card battle game execution control unit 71a executes attack determination processing (P6-11). In the attack determination processing, the physical strength of the follower card or the leader 41a of the player that has been attacked is reduced, and the physical strength of the follower card that has attacked is reduced. In addition, the display control unit 73a produces a rendition for the attack.

Then, the card battle game execution control unit 71a determines whether winning or losing has been decided (P6-12). When winning or losing has been decided (YES in P6-12), the opponent's turn control processing is ended, and when winning or losing has not been decided (NO in P6-12), the processing proceeds to P6-13.

The evolution processing unit 74a determines whether evolution information has been received via the communication control unit 75a (P6-13). When the evolution information has been received (YES in P6-13), the evolution processing unit 74a reduces the evolution point 43b (P6-14). The display control unit 73a updates and displays the evolution point 43b. The evolution processing unit 74a increases and updates the performance (for example, the attack power and the physical strength) of a follower card to be evolved (P6-15). The evolution processing unit 74a checks the ability 55 of the evolved card, and when there is the ability 55 to be activated, activates the ability 55 (P6-16). Then, the evolution processing unit 74a determines whether winning or losing has been decided (P6-17). When winning or losing has been decided (YES in P6-17), the opponent's turn control processing is ended, and when winning or losing has not been decided (NO in P6-17), the processing proceeds to P6-18.

The card battle game execution control unit 71a determines whether turn end information has been received via the communication control unit 75a (P6-18). When the turn end information has been received (YES in P6-18), the card battle game execution control unit 71a executes the turn end processing (P5-19). Here, the card battle game execution control unit 71a checks the ability 55 of the card arranged in the area 46b. When there is the ability 55 to be activated at the end of the opponent's turn, the ability 55 is activated, and winning or losing is checked. When it is determined that winning or losing has been decided in P6-9, P6-12, P6-17, or P6-19 described above, the communication control unit 75a transmits win/loss information indicating that winning or losing has been decided to the server 100.

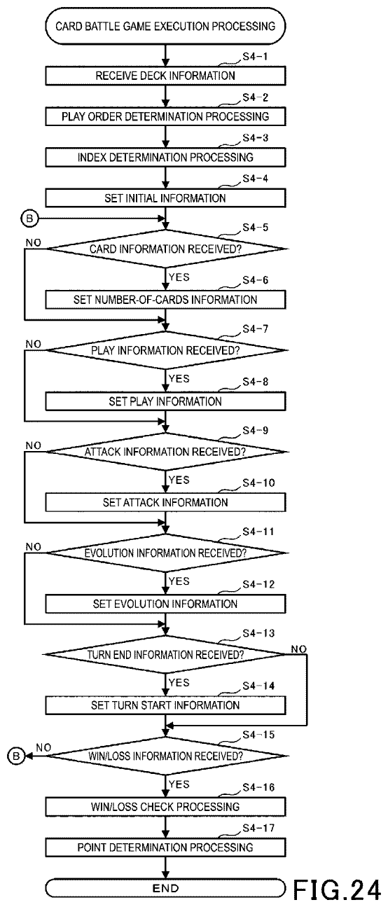

FIG. 24 is a flowchart illustrating an example of the card battle game execution processing (S4) in the server 100. When the card battle game execution processing is started, the communication control unit 172a receives deck information from the player terminal 1 of the player and the player terminal 1 of the opponent (S4-1). Then, the card battle game execution control unit 171a determines the play order (S4-2), assigns indices to cards included in the deck information (S4-3), and causes the player terminal 1 of the player and the player terminal 1 of the opponent to receive the initial information (S4-4).

The card battle game execution control unit 171a determines whether card information has been received via the communication control unit 172a (S4-5). When the card information has been received (YES in S4-5), the communication control unit 172a causes the player terminal 1 of the opponent, which is different from the player terminal 1 from which the card information has been received, to receive the number-of-cards information (P4-6).

The card battle game execution control unit 171a determines whether play information has been received via the communication control unit 172a (S4-7). When the play information has been received (YES in S4-7), the communication control unit 172a causes the player terminal 1 of the opponent, which is different from the player terminal 1 from which the play information has been received, to receive the play information (S4-8).

The card battle game execution control unit 171a determines whether attack information has been received via the communication control unit 172a (S4-9). When the attack information has been received (YES in S4-9), the communication control unit 172a causes the player terminal 1 of the opponent, which is different from the player terminal 1 from which the attack information has been received, to receive the attack information (S4-10).

The card battle game execution control unit 171a determines whether evolution information has been received via the communication control unit 172a (S4-11). When the evolution information has been received (YES in S4-11), the communication control unit 172a causes the player terminal 1 of the opponent, which is different from the player terminal 1 from which the evolution information has been received, to receive the evolution information (S4-12).

The card battle game execution control unit 171a determines whether turn end information has been received via the communication control unit 172a (S4-13). When the turn end information has been received (YES in S4-13), the communication control unit 172a causes the player terminal 1 of the opponent, which is different from the player terminal 1 from which the turn end information has been received, to receive the turn end information and turn start information (S4-14).

The card battle game execution control unit 171a determines whether win/loss information has been received via the communication control unit 172a (S4-15). When the win/loss information has been received (YES in S4-15), the card battle game execution control unit 171a executes win/loss check processing of checking whether winning and losing are correct based on the information received until this point (S4-16). When it is determined that winning and losing are correct in the win/loss check processing, the card battle game execution control unit 171a calculates the battle points of the player and the opponent (S4-17). In addition, the communication control unit 172a causes the player terminals 1 to receive the battle point and terminates the card battle game execution processing.

One aspect of the embodiment has been described above with reference to the accompanying drawings, but it goes without saying that the present invention is not limited to the above-described embodiment. It is apparent to those skilled in the art that various modifications and corrections can be made within the scope of the claims, and it should be understood that such modifications and corrections also obviously fall within the technical scope of the present disclosure.

Although the digital card game has been described as an example in the above-described embodiment, genres and contents of the game are not particularly limited, and includes a simulation game, for example. In any case, the game only needs to be a match-up game using game media, and the opponent is not limited to a person and may be a computer. Thus, the game media are not limited to digital cards, and are any game media provided in a game, such as characters, units, or pieces.

In the above-described embodiment, the information processing system S, which is a client server system, performs the above-described information processing. However, the function of the server 100 in the above-described embodiment may be provided in the player terminal 1. The function of the player terminal 1 in the above-described embodiment may be provided in the server 100. The communication function is not essential, and for example, a match-up against a computer or a match-up between a plurality of players may be executable in the game apparatus G. In any case, the information processing program suitably causes a computer to execute the following processing.

### Processing Executed by Computer

Processing of displaying a game medium of a player and a game medium of an opponent among a plurality of game media (e.g., digital cards in the embodiment) associated with display modes and performances in an arrangement region (e.g., the area 46a in the embodiment) in a recognizable manner (e.g., P5-9 and P6-7 in the embodiment).

Processing of progressing a game based on at least an operation input with respect to the game medium displayed in the arrangement region (e.g., the processing of FIG. 20 to FIG. 24 in the embodiment).

Processing to be performed such that, in a case where a specific game medium (e.g., the card having a card name of “Bear” in the embodiment) associated with a specific display mode (e.g., the illustration before evolution in the top row of FIG. 15 in the embodiment) and a specific performance (e.g., the ability before evolution in the top row of FIG. 15 in the embodiment) from among a plurality of game media is displayed in the arrangement region and a predetermined operation input (e.g., tapping of the card displayed in the area 46a in the embodiment) is performed on the specific game medium, when a specific condition set in advance (e.g., the fact that a predetermined card is displayed in the area 46a in the embodiment) is not satisfied, one or both of the specific display mode and the specific performance is/are changed to a preset display mode (e.g., the illustration after evolution in the top row of FIG. 15 in the embodiment) or a preset performance (e.g., the ability after evolution in the top row of FIG. 15 in the embodiment), and when the specific condition is satisfied, one or both of the specific display mode or the specific performance is/are be changed to any of a plurality of display modes (e.g., the illustrations before evolution in the second to fourth rows in FIG. 15 in the embodiment) or a plurality of performances (the abilities after evolution in the second to fourth rows of FIG. 15 in the embodiment) (e.g., P5-33 in the embodiment).

The plurality of game media include a plurality of special game media that are different from the specific game medium in one or both of the display mode and the performance (e.g., special cards in the embodiment), and the specific game medium may be changed to any of the plurality of special game media when the specific condition is satisfied.

The computer may further execute processing of prompting the player to select any of the plurality of special game media when the specific condition is satisfied (e.g., P5-29 in the embodiment). In that case, the specific game medium is suitably changed to the special game medium selected by the player.

One or both of the display mode and the performance of a special game medium may be different from a preset display mode or a preset performance resulting from the changing when the specific condition is not satisfied.

The specific condition may be determined to have been satisfied when the operation input by the player during a predetermined period satisfies a condition set in advance.

Note that in the above-described embodiment, three special cards are associated with a specific card. However, special cards to be associated with a specific card may be added or changed by update, for example. In that case, for example, a plurality of special cards may be associated with a specific card in advance, and a special card selectable by the player may be automatically added at a predetermined date and time. At this time, for example, a new card is suitably added to or changed in a database of cards stored in the server 100. Alternatively, for example, a special card may be added or changed manually by the administrator.

The program according to the above-described embodiment may be stored in a non-transitory computer-readable storage medium and provided as a storage medium. Further, a game terminal device or an information processing system including the storage medium may be provided. In addition, the above-described embodiment may be an information processing method for implementing the respective functions and the steps illustrated in the flowcharts.

What is claimed is:

1. A non-transitory computer readable medium storing a program causing a computer to execute:
displaying, in an arrangement region in a recognizable manner, a game medium of a player and a game medium of an opponent out of a plurality of game media each of which is associated with a display mode and a performance;
progressing a game based on at least an operation input with respect to the game medium displayed in the arrangement region; and
when a specific game medium associated with a specific display mode and a specific performance out of the plurality of game media is displayed in the arrangement region and a predetermined operation is input with respect to the specific game medium, changing one or both of the specific display mode and the specific performance to a preset display mode or a preset performance when a specific condition set in advance is not satisfied, and changing one or both of the specific display mode and the specific performance to any of a plurality of display modes or performances when the specific condition is satisfied.

2. The non-transitory computer readable medium according to claim 1, wherein
the plurality of game media include a plurality of special game media each of which is different from the specific game medium in one or both of a display mode and a performance, and
in the changing the display mode or the performance, the specific game medium is changed to any of the plurality of special game media when the specific condition is satisfied.

3. The non-transitory computer readable medium according to claim 2, wherein
the program further causes the computer to execute prompting the player to select a special game medium of the plurality of special game media when the specific condition is satisfied, and
in the changing the display mode or the performance, the specific game medium is changed to the special game medium selected by the player.

4. The non-transitory computer readable medium according to claim 3, wherein one or both of the display mode and the performance of the special game medium is or are different from the preset display mode or the preset performance resulting from the changing when the specific condition is not satisfied.

5. The non-transitory computer readable medium according to claim 1, wherein the specific condition is determined to have been satisfied when a progress status of the game during a predetermined period satisfies a condition set in advance.

6. An information processing method executed by one or more computers, the information processing method comprising:
displaying, in an arrangement region in a recognizable manner, a game medium of a player and a game medium of an opponent out of a plurality of game media each of which is associated with a display mode and a performance;
progressing a game based on at least an operation input with respect to the game medium displayed in the arrangement region; and
when a specific game medium associated with a specific display mode and a specific performance out of the plurality of game media is displayed in the arrangement region and a predetermined operation is input with respect to the specific game medium, changing one or both of the specific display mode and the specific performance to a preset display mode or a preset performance when a specific condition set in advance is not satisfied, and changing one or both of the specific display mode and the specific performance to any of a plurality of the display modes or the performances when the specific condition is satisfied.

7. A game apparatus comprising one or more computers,
the one or more computers being configured to execute:
displaying, in an arrangement region in a recognizable manner, a game medium of a player and a game medium of an opponent out of a plurality of game media each of which is associated with a display mode and a performance;
progressing a game based on at least an operation input with respect to the game medium displayed in the arrangement region; and
when a specific game medium associated with a specific display mode and a specific performance out of the plurality of game media is displayed in the arrangement region and a predetermined operation is input with respect to the specific game medium, changing one or both of the specific display mode and the specific performance to a preset display mode or a preset performance when a specific condition set in advance is not satisfied, and changing one or both of the specific display mode and the specific performance to any of a plurality of the display modes or the performances when the specific condition is satisfied.
